(19) United States
(12) Patent Application Publication
(10) Pub. No.: US 2026/0244157 A1
(43) Pub. Date: Aug. 20, 2026

(54) CURVED LIGHTGUIDES WITH SPATIAL LIGHT MODULATORS FOR AUGMENTED REALITY APPLICATIONS

(71) Applicants: Swave Photonics Inc., Redmond, WA (US); Swave BV, Leuven (BE)

(72) Inventor: Michal Makowski, Kirkland, WA (US)

(73) Assignees: Swave Photonics Inc., Redmond, WA (US); Swave BV, Leuven (BE)

(21) Appl. No.: 19/539,291

(22) Filed: Feb. 13, 2026

Related U.S. Application Data
(60) Provisional application No. 63/759,512, filed on Feb. 17, 2025.
(60) Provisional application No. 63/759,816, filed on Feb. 18, 2025.
(60) Provisional application No. 63/862,876, filed on Aug. 13, 2025.

(51) Int. Cl. G03H 1/22

(52) U.S. Cl. CPC G03H 1/2294

(57) ABSTRACT

Disclosed herein are curved lightguides with spatial light modulators (SLMs) for augmented reality (AR) applications and associated devices and systems. An example AR display hardware includes a lightguide having a concave outer surface and a convex outer surface (e.g., the lightguide is a curved lightguide); and an SLM attached to a portion of the lightguide, wherein the lightguide includes a first diffractive optical element (DOE) for outcoupling light incident thereon and a second DOE for outcoupling light incident thereon, the first DOE is over a portion of the concave outer surface of the lightguide, and the second DOE is over a portion of the convex outer surface of the lightguide.

### CROSS-REFERENCE TO RELATED APPLICATIONS

This application claims the benefit of 1) U.S. Provisional Patent App. No. 63/759,512, entitled “SYSTEM AND METHODS FOR DISPLAY OF 3D MULTI-MEDIA,” filed on Feb. 17, 2025, 2) U.S. Provisional Patent App. No. 63/759,816, entitled “SYSTEM AND METHODS FOR DISPLAY OF 3D MULTI-MEDIA,” filed on Feb. 18, 2025, and 3) U.S. Provisional Patent App. No. 63/862,876, entitled “CURVED LIGHTGUIDES WITH SPATIAL LIGHT MODULATORS FOR AUGMENTED REALITY APPLICATIONS,” filed on Aug. 13, 2025, the disclosures of which are expressly incorporated herein by reference in their entirety.

### BACKGROUND

Spatial light modulation refers to the process of dynamically controlling the spatial properties of light, such as its amplitude, phase, and/or polarization, across a two-dimensional surface or grid. This is typically achieved using a spatial light modulator (SLM), which is a device that includes an array of light modulation elements (sometimes referred to as “SLM pixels” or simply “pixels”), each capable of modulating light incident thereon.

The ability of SLM pixels to individually manipulate light enables the formation of highly complex optical wavefronts, making SLMs invaluable in applications such as holographic displays, augmented reality (AR) devices, virtual reality (VR) devices, head-up displays, volumetric displays, advanced imaging, and optical processing systems. For example, in holographic displays, light modulation by the SLMs allows the reconstruction of 3D images that appear volumetric and can be viewed from multiple perspectives without the need for special eyewear. In AR and VR systems implementing holographic displays, SLMs may be used to display virtual content into an observer's field of view (FoV) in a way that accurately matches the depth and spatial characteristics of the real environment, enhancing immersion and realism. For example, in AR applications, SLMs enable the integration of virtual content into the real-world view by displaying virtual images directly into the observer's FoV while allowing the observer to simultaneously see the physical environment. This allows AR glasses or headsets to overlay holographically-generated 3D content, such as annotations, objects, or interactive elements, on top of what the observer sees in real life.

### BRIEF DESCRIPTION OF THE DRAWINGS

Embodiments will be readily understood by the following detailed description in conjunction with the accompanying drawings. To facilitate this description, similar reference numerals designate similar structural elements. Embodiments are illustrated by way of example, and not by way of limitation, in the figures of the accompanying drawings.

FIG. 1 provides a schematic illustration of a holographic display system in which curved lightguides with SLMs for AR applications may be used, according to some embodiments.

FIG. 2 provides a cross-sectional side view of an example SLM array, according to some embodiments.

FIG. 3 provides a perspective illustration of AR glasses with an SLM and a curved lightguide, according to some embodiments.

FIGS. 4A and 4B provide top views of a curved lightguide with an SLM, illustrating a FoV delivered by, respectively, a transmissive diffractive optical element (DOE) and a reflective DOE, according to some embodiments.

FIGS. 5A and 5B provide top views of a curved lightguide with an SLM, illustrating light beams incident on, respectively, a reflective DOE and a transmissive DOE, when an optical fiber is coupled to a convex surface of the curved lightguide, according to some embodiments.

FIGS. 6A and 6B provide top views of a curved lightguide with an SLM, illustrating light beams incident on, respectively, a reflective DOE and a transmissive DOE, when an optical fiber is coupled to a concave surface of the curved lightguide, according to some embodiments.

FIGS. 7A-7C provide a perspective illustration of AR glasses with an SLM and a curved lightguide, according to further embodiments.

FIG. 8 illustrates a top view of a left side of example AR glasses comprising a free-space light engine composed of an optical submodule and a flat DOE.

FIG. 9 illustrates a top view of a left side of another example of AR glasses comprising a free-space light engine composed of an optical submodule and a curved DOE.

FIG. 10 shows a top view of a left side of example AR glasses with a flat lightguide comprising a transmissive DOE.

FIG. 11 illustrates a close-up cross-sectional top view of a portion of a flat lightguide showing two total internal reflection (TIR) rays traveling inside the flat lightguide.

FIG. 12 illustrates a top view of a left side of another example of AR glasses with a flat lightguide comprising a reflective DOE.

FIG. 13 illustrates a top view of a left side of another example of AR glasses, whereby an SLM is attached to a flat lightguide.

FIG. 14 illustrates a top view of a left side of another example of AR glasses comprising a flat lightguide, a plano-concave lens, and a plano-convex lens.

FIG. 15 illustrates a top view of a left side of another example of AR glasses comprising a flat lightguide and a curved lens.

FIG. 16 illustrates a flat lightguide whereby an SLM is attached to a slanted side surface of the flat lightguide.

FIG. 17 illustrates a flat lightguide whereby an SLM is attached to a slanted side surface of the flat lightguide, further comprising an optical element that converts an incoming illumination beam into a converging illumination beam incident on the SLM.

### DETAILED DESCRIPTION

Disclosed herein are curved lightguides with SLMs for AR applications and associated devices and systems. The systems, methods, and devices of this disclosure each have several innovative aspects, no single one of which is solely responsible for all the desirable attributes disclosed herein. Details of one or more implementations of the subject matter described in this specification are set forth in the description below and the accompanying drawings.

For purposes of illustrating curved lightguides proposed herein, it might be useful to first understand phenomena that may come into play in holography with SLMs for AR applications. The following foundational information may be viewed as a basis from which the present disclosure may be properly explained. Such information is offered for purposes of explanation only and, accordingly, should not be construed in any way to limit the broad scope of the present disclosure and its potential applications.

An SLM can refer to an optical device comprising an array of light modulation elements configured to modulate the amplitude, phase, and/or polarization of an electromagnetic field, such as, but not limited to, a wavefront of an illumination beam or an optical light field. In an example, an SLM is an optical device that includes an array of individually addressable light modulation elements configured to modulate one or more of the amplitude, phase, and/or polarization of the wavefront of an illumination beam or of the optical light field incident to the optical device. In various examples herein, terms such as “light modulation elements,” “optical pixels,” “SLM pixels,” “pixels,” or “active cells” may be used interchangeably throughout to refer to individual light modulation elements that together form an SLM array. Also, terms such as “SLM array,” “SLM device,” and “SLM” may be used interchangeably. In an example, an SLM includes an array of light modulation elements, where each light modulation element is configured to switch between at least two different optical states. In an example, each optical state of a light modulation element of the SLM exhibits different optical properties so that a light modulation element of the SLM responds differently to incident light based on the optical state of that light modulation element.

Example applications for SLMs include digital holography. In digital holography (also referred to as “computer-generated holography (CGH)”), an SLM plays a central role by dynamically encoding the amplitude information, the phase information, or both the amplitude and phase information of a light interference pattern. A hologram is a light interference pattern that encodes the amplitude and phase information of light scattered from a three-dimensional (3D) object, enabling the reconstruction of a realistic 3D image when appropriately illuminated. Unlike traditional holography, which records hologram patterns on photographic film, digital holography uses computational methods such as numerical wave propagation techniques (e.g., Fourier or Fresnel transforms) to synthesize these patterns. To embody a computer-generated hologram, one or more operational/physical states (e.g., refractive index, orientation, or optical path length) of individual pixels of an SLM are electronically programmed according to the information contained in the hologram. This programming enables the SLM pixels to alter specific optical properties of light illuminating them to modulate the amplitude and/or phase (and in some cases, and/or the polarization) of the light passing through or reflected from each SLM pixel. When light modulated by the SLM is projected into space, these programmed alterations collectively shape the wavefront for a viewer to perceive an intended reconstructed 3D image, thereby transforming the SLM into a dynamic, reconfigurable medium for holographic projection.

In some embodiments, the light emerging from the SLM does not inherently reach the viewer's eyes in the correct orientation or position. Therefore, additional optical components are needed to capture and guide the modulated wavefront toward the correct viewing zone. For example, in AR applications, light modulated by the SLM may be optically redirected toward the viewer's eyes using appropriate AR display hardware, such as AR glasses, headsets, visors, or similar wearable devices.

Designing AR display hardware capable of properly presenting holographic content while maintaining a visually appealing and practical form factor is a nontrivial challenge. One possible approach involves implementing the display using flat lightguides, which can be optically efficient and compact. However, flat AR display hardware, such as glasses with flat lenses, may not be aesthetically pleasing, as most conventional eyewear is slightly curved to match facial contours. Furthermore, flat lightguides are difficult to integrate with prescription lenses, which are typically curved to correct for vision impairments and ensure that light focuses properly on the retina. In order to integrate prescription lenses with flat lightguides, a concave lens (e.g., a plano-concave lens) may be placed on the inner (eye-facing) surface of the lightguide, and/or a convex lens (e.g., a plano-convex lens) may be applied to the outer surface. In some implementations, a separate curved lens may be positioned in front of or behind the flat lightguide. However, incorporating concave, convex, or curved lenses in combination with flat lightguides results in increased lens thickness and bulk, which is undesirable for creating compact, lightweight AR glasses suitable for extended wear.

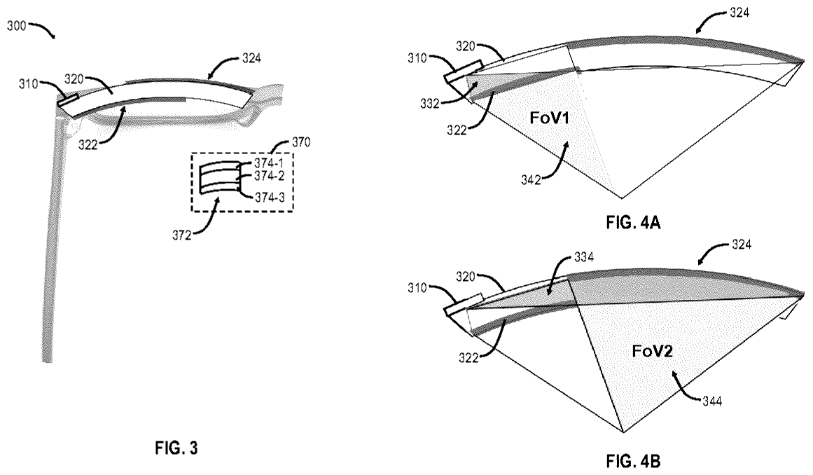

Some embodiments of the present disclosure are based on the recognition that a curved lightguide may serve as a more effective foundation for AR display hardware, compared to a flat lightguide. Similar to a flat lightguide, a portion of the curved lightguide's surface can serve as an incoupling region for light modulated by the SLM. The incoupling process may be invisible to the viewer, as the SLM and any accompanying optical components used to direct light into the lightguide can be integrated or encapsulated within the frame of the AR display hardware. In some embodiments, the SLM can be attached directly to the outer surface of the curved lightguide opposite the side of the viewer's eye (the convex outer surface of the curved lightguide) and the illumination can be directed to the SLM through a portion of the lightguide, enabling a particularly compact solution. In other embodiments, the SLM can be attached to the concave outer surface of the curved lightguide. In yet other embodiments, instead of the SLM being attached to one of the convex outer surface or the concave outer surface of the curved lightguide, the SLM can be attached to a side wall of the curved lightguide. In other words, the SLM can be attached to an edge of the curved lightguide. The side wall of the curved lightguide onto which the SLM is applied can be chamfered at an angle so that the SLM is angularly mounted. A curved lightguide may include a transmissive DOE applied to a portion of the outer surface that is closest to the viewer's eyes and a reflective DOE applied to a portion of the opposite outer surface (i.e., the lightguide outer surface that is farthest from the viewer's eyes). Both the transmissive and reflective DOEs assist in the outcoupling of light from the lightguide towards the viewer's eyes. In particular, these DOEs are designed to cooperatively deliver different portions of the overall FoV to the viewer, such that the complete image is reconstructed. In some implementations, the transmissive and reflective DOEs do not overlap, or only partially overlap, in their spatial coverage. In some related embodiments, the overlap between the transmissive DOE and reflective DOE in their spatial coverage is relatively small. Light rays within the curved lightguide do not propagate via TIR over extended paths before being outcoupled. Instead, the transmissive and reflective DOEs are designed and placed on a curved lightguide so that, once a light ray reaches an interior surface (surface at the inside of the lightguide) of the curved lightguide for the first time, it will directly reach either the transmissive DOE or the reflective DOE, upon which it will exit the lightguide (e.g., after being reflected for light rays reaching the reflective DOE) and be directed to the viewer's eye. The reflective DOE, located on the outward-facing surface opposite the viewer's eye, reflects incident light back through a portion of the lightguide toward the eye, where it then exits the lightguide and is perceived by the viewer (i.e., because the reflective DOE is applied at the outer surface of the curved lightguide opposite the side of the viewer's eye, light rays reaching the reflective DOE are reflected to the viewer's eye and therefore still need to travel through a small portion of the curved lightguide before actually exiting the lightguide). Curved lightguides are described herein with reference to, e.g., FIGS. 3-7.

In one aspect, an example AR display hardware includes a lightguide having a concave outer surface and a convex outer surface (e.g., the lightguide is a curved lightguide); and an SLM attached to a portion of the lightguide, wherein the lightguide includes a first DOE for outcoupling light incident thereon and a second DOE to assist outcoupling of light incident thereon, the first DOE is over a portion of the concave outer surface of the lightguide, and the second DOE is over a portion of the convex outer surface of the lightguide.

In some embodiments, any of the DOEs described herein may be a holographic optical element (HOE), where an HOE refers to a thin, transparent optical component, such as a coating applied to a surface of a lightguide, that contains a holographically recorded diffraction pattern (i.e., a hologram) designed to precisely manipulate light (e.g., using principles of diffraction). This manipulation may include bending, filtering, or redirecting light within an AR optical system. In some embodiments, any of the HOEs described herein may be a volume hologram. In other embodiments, any of the DOEs described herein may be a metasurface. In other embodiments, any of the DOEs described herein may take forms other than volume holograms and metasurfaces as long as the light manipulation imposed by them is based on principles of diffraction. In some embodiments, any of the DOEs described herein may be designed to have the optical functionality of one or more optical components such as a prism, a lens, and/or a beam splitter. In other embodiments, any of the DOEs described herein may be a surface-relief DOE. A surface-relief DOE may be implemented as physical height or shape variations on a surface (e.g., tiny steps or grooves).

As used herein, the term “volume hologram” refers to a thin, transparent optical component that contains a holographically recorded diffraction pattern (i.e., a hologram) extending through a 3D volume. In some embodiments, a volume hologram can be realized in the form of a periodic modulation of the refractive index in the volume by using two or more distinct materials with different refractive indices. Unlike a surface-relief hologram, which encodes information only on its surface, a volume hologram stores the interference pattern within/throughout the depth of its internal structure, enabling more complex and efficient light manipulation. This internal structure allows the volume hologram to selectively bend, filter, or redirect (e.g., diffract) light with high precision, improving optical performance in, for example, a holographic display system.

In some embodiments, a volume hologram may include a single material where the refractive index varies periodically. In other words, a volume hologram may include a single material with a refractive index modulation. In some embodiments, the refractive index modulation may be realized under optical exposure (e.g., light exposure) causing small local changes in the refractive index. In alternative embodiments, a volume hologram may use at least two distinct materials with different refractive indices.

In some embodiments, a volume hologram may include a set of interference fringes formed within the holographic medium by the interference of two coherent beams during the recording process. These interference fringes define alternating regions of constructive and destructive intensity within the material, creating a periodic modulation of the refractive index throughout the volume. The vector perpendicular to the interference fringes is commonly known as a “K-vector,” and represents the spatial frequency and direction of the recorded grating. The angle between the K-vector and an axis perpendicular to the top surface of the medium comprising the volume hologram is referred to as a “fringe slant angle,” while the rotation of the fringes around an axis perpendicular to the top surface of the medium comprising the volume hologram is referred to as a “clocking angle.” These parameters, combined with the thickness of the medium and its modulation of the refractive index, collectively determine the diffraction characteristics of the volume hologram, including its angular and spectral selectivity, thus determining which functionalities the volume hologram is configured to perform.

A volume hologram can be conceptually understood as a stack of microscopic layers, each functioning as a diffraction grating. This layered structure produces what is known as “Bragg selectivity,” a property whereby the hologram diffracts only light of a specific wavelength incident at a specific angle, while transmitting other wavelengths and angles with minimal interaction. The high angular and wavelength selectivity of the volume hologram enables precise control of light propagation, making it particularly suitable for implementing functionalities such as beam redirection, wavelength filtering, and stray light suppression within holographic display systems.

As used herein, the term “metasurface” refers to an ultrathin optical structure comprising a two-dimensional array of subwavelength features (e.g., nano-antennas, nano-pillars, or other engineered scattering elements), each having a geometry, orientation, material composition, or other physical property selected to impart a predetermined modification to one or more characteristics of incident light.

In some embodiments, a metasurface may be realized by the use of micro/nanofabrication techniques to pattern tiny “meta-atoms” (e.g., pillars, fins, holes, antennas) on a surface with feature sizes/dimensions typically smaller than the wavelength of light being manipulated, i.e., with subwavelength feature sizes/dimensions (e.g., dimensions below one or more of the wavelengths of visible light). In some embodiments, the feature size of a meta-atom may be smaller than or equal to half-wavelength (e.g., with reference to a wavelength of visible light, which may lie in a range of around 380 nm to around 750 nm). In some embodiments, the feature size of a meta-atom may be equal to or smaller than one fifth or one tenth of the wavelength. In various embodiments, one or more of techniques such as thin-film deposition, lithography, or etching may be used to form metasurfaces.

A transmissive DOE is a DOE that modifies light as it passes through the DOE. It diffracts or redirects incoming light while allowing it to continue in the same general direction. A reflective DOE is a DOE that reflects and redirects light, typically by diffracting incident light back toward a desired direction. Unlike mirrors, a reflective DOE placed on an outer surface of a curved lightguide can be designed to reflect specific wavelengths or angles with high precision, allowing for selective and efficient light management.

In various examples, optical pixels of an SLM can be adapted to respond to programmed signals enabling the SLM to modulate wavefronts of an illumination beam or to generate dynamic optical light fields. In an example, optical pixels of an SLM array can be programmed to generate video holography. In various examples, a display/projection device and/or an AR device can integrate one or more SLM devices, such as SLM devices based on one or more integrated circuits (ICs). In an example, the one or more SLM devices integrated in a display/projection device and/or in an AR device can be used to display/project two-dimensional (2D) or three-dimensional (3D) images with digital holography. In various descriptions herein, the term “hologram” and/or “hologram pattern” can refer to an interference pattern displayed on an SLM or included in the DOEs (e.g., in the HOEs) on the opposite surfaces of a curved lightguide. The term “reconstructed hologram” refers to the visual image or scene perceived when a hologram on the SLM is illuminated and may appear either 2D or 3D depending on the encoded information. In an example, an SLM can be used for the rendering of a hologram pattern, and the hologram pattern as rendered on the SLM can subsequently be illuminated by an illumination beam. The hologram pattern on the SLM modulates the wavefront of the illumination beam. In other examples, when a wavefront as modulated by an SLM is perceived by a viewer, the viewer can perceive reconstructed holograms representative of digital 2D scenes and/or digital 3D scenes encoded in the hologram patterns as rendered on the SLM. In related examples, many digital 2D and/or digital 3D images and scenes may be designed for display in color, e.g., when providing digital 2D images and/or digital 3D scenes in a single color (monochrome) can result in a less than immersive experience for the viewer.

In the context of AR systems, an SLM may serve to provide dynamic holograms that evolve in real time (i.e., holograms displayed on an SLM may be dynamically changing). In contrast, the DOEs applied to the outer surfaces of a curved lightguide are static optical components. For example, for DOEs implemented as HOEs, their holograms are fixed during fabrication and do not change during operation. Together, the dynamic holograms rendered by the SLM and the static holograms embedded in the transmissive and reflective DOEs (e.g., for the case where DOEs are implemented as HOEs) on opposing surfaces of a curved lightguide collaborate to shape and steer the outgoing wavefront. This coordinated optical manipulation enables a viewer to perceive reconstructed 2D/3D images, providing the foundation for advanced AR visual displays.

In an example, the pixel pitch of an SLM can determine a FoV for the SLM, where progressively reduced pixel pitch enables SLMs with wider FoV. In many examples, a relatively large FoV can be desirable for digital holography applications, e.g., in order to provide an acceptably immersive experience for a viewer. Example SLMs implemented with a pixel pitch below 1 micron (μm), including a pixel pitch below the wavelengths of visible light, can be advantageous to enable implementation of a given SLM in digital holography applications. In an example, the wavelengths of visible light can range from approximately 380 nanometers (nm) to approximately 750 nm, e.g., from approximately 400 nm to approximately 700 nm. In some embodiments, SLMs used with curved lightguides described herein may employ subwavelength pixels, where, as used herein, the term “subwavelength pixel” refers to pixels of the SLM with a pixel pitch below one or more of the wavelengths of visible light. Similarly, the term “subwavelength” used with any other dimension refers to that dimension being below one or more of the wavelengths of visible light, e.g., the dimension being less than about 750 nm, e.g., less than about 700 nm or less than about 650 nm. In some embodiments, SLMs with subwavelength pixels may be implemented using active cells based on phase-change material (PCM) which can be suitable for digital holography applications. In some embodiments, SLMs used with curved lightguides described herein may employ pixels with a pixel pitch below half the wavelength of one or more wavelengths of visible light.

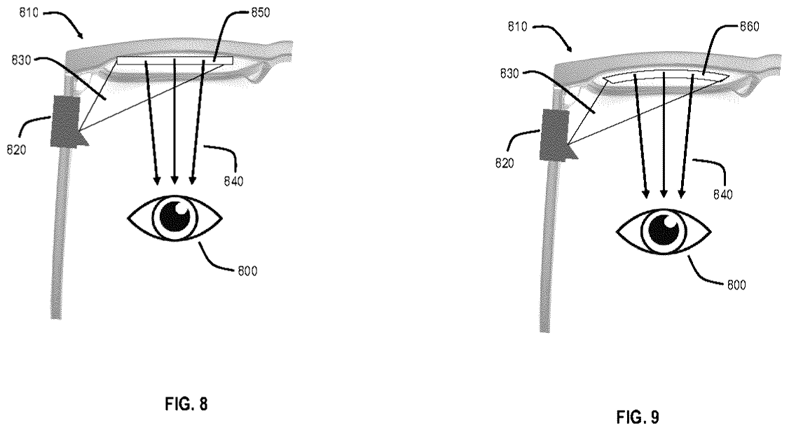

Other embodiments of the present disclosure relate to free-space optics light engines and flat lightguides to be used with SLMs, e.g., as described with reference to FIGS. 8-17.

To facilitate understanding of the illustrative implementations, certain numerical values, materials, and configurations are provided by way of example. However, it will be understood by those skilled in the art that the disclosed concepts can be implemented without relying on these specific details, or by applying only selected aspects thereof. Additionally, commonly known features and components may be omitted or presented in a simplified manner so as not to detract from the clarity of the illustrative embodiments.

In the following detailed description, various aspects of the illustrative implementations may be described using terms commonly employed by those skilled in the art to convey the substance of their work to others skilled in the art. For example, in the context of CGH, the term “hologram” or “hologram pattern” refers to a digitally computed two-dimensional pattern comprising modulated optical properties such as amplitude, phase, or a combination thereof, designed to diffract incident light in a manner that reconstructs a desired optical wavefront corresponding to a target image. Such a hologram may be generated using numerical wave propagation techniques (e.g., Fourier or Fresnel transforms) based on a virtual representation of a target image and subsequently rendered on an SLM array by altering the operational/physical states of individual light modulation elements of the SLM array to modulate the amplitude and/or phase (and in some cases and/or the polarization) of the light passing through or reflected from each SLM element. As used herein, the term “SLM array” may refer to or be used interchangeably with terms such as “SLM,” “an array of light modulation elements,” or “an array of unit cells.” Additionally, the term “SLM pixel” may be used interchangeably with “pixel,” “light modulation element,” or “unit cell.”

In another example, the term “image” as used in reference to a target image or to a reconstructed image refers to a virtual representation of a scene that may be two-dimensional (2D) or three-dimensional (3D) in nature. Such a scene may include one or more objects, each defined by spatial attributes such as shape, texture, depth, color, and optical properties (e.g., reflectance, transparency). A 2D image displayed by an AR system typically resides on a single depth plane in space and encodes visual content without depth cues different from the location of that single depth plane in space, whereas a 3D image includes volumetric or multi-depth information that enables realistic depth perception when reconstructed. The image may be static or dynamic (time-varying) and may include multiple depth layers or continuous depth encoding depending on the system capabilities. In this context, the target image is an image that serves as the basis for numerical wavefront calculations, while the reconstructed image refers to the optical output produced by the hologram when illuminated, which recreates the intended visual appearance of the original scene through diffraction and interference. The reconstructed image can exhibit parallax, occlusion, and depth-dependent focus cues, thereby supporting perception of real-world spatial structures. The term “reconstructed image” may be used interchangeably with expressions such as “reconstructed holographic scene,” “reconstructed holographic scene/imagery,” “reconstructed scene/imagery,” “reconstructed virtual scene/imagery,” “virtual scene/imagery,” or “virtual content.”

The term “replay field” (RPF) refers to the spatial region where the reconstructed image (holographically-generated scene) appears after the hologram is illuminated (or “replayed”) by the appropriate light sources. This field represents the volume or area in the 3D space in which a target image is displayed for a viewer to perceive.

As used herein, the term “light” generally refers to electromagnetic radiation within the visible spectrum that is used to illuminate an SLM or to reconstruct a holographically-generated image. The ideal source of light for generating and reconstructing holograms is light with one or more discrete wavelengths, such as that produced by a laser. For example, a multi-wavelength laser may be designed to produce light having one component having a wavelength of about 625 nm (red light), one component having a wavelength of about 530 nm (green light), and one component having a wavelength of about 460 nm (blue light), which is an example of a light source producing three discrete wavelengths. In another example, a single-wavelength laser may be designed to produce light of only one discrete wavelength, e.g., 625 nm (red light). However, practical implementations may utilize light sources that emit within a narrow non-zero spectral bandwidth around each discrete wavelength. For example, a laser designed to emit light at a certain wavelength does not only emit light of that one exact wavelength but emits light that is centered around that wavelength in a narrow but non-zero bandwidth (e.g., 5 nm). In such cases, the term “wavelength of the light” refers to the central wavelength of the spectral distribution. For a given discrete wavelength, this narrowband light may still be considered effectively monochromatic for holographic purposes. In some embodiments, the spectral bandwidth of individual discrete wavelengths of light described herein may include a range of wavelengths within (i.e., ±) 1 nanometer (nm), from the central wavelength, e.g., within ±300 picometers (pm) or within 30 pm. The term “light” may refer to, or be used interchangeably with, expressions such as “light beam,” “optical radiation,” “illumination,” “coherent light,” or “partially coherent light,” particularly when discussing propagation through or modulation by optical components within the system.

Terms such as “substantially,” “approximately,” “close,” “near,” and “about” generally indicate values within ±10%, e.g., within ±5% or ±2%, of a given target, depending on the particular context or established conventions in the field. Similarly, spatial descriptors like “coplanar,” “perpendicular,” “parallel,” “orthogonal,” or similar terms describing angular relationships should be interpreted as allowing for minor deviations within similar tolerances. Terms describing spatial relationships, such as “over,” “under,” “between,” and “on,” refer to relative positioning of one material layer or component with respect to other layers or components. For instance, one layer disposed over or under another layer may be directly in contact with the other layer or may have one or more intervening layers. Moreover, one layer disposed between two layers may be directly in contact with the two layers or may have one or more intervening layers. In contrast, a first layer or component described to be “on” a second layer or component is in direct contact (e.g., in direct physical contact) with that second layer or component. Similarly, unless explicitly stated otherwise, one feature disposed between two features may be in direct contact (e.g., in direct physical contact) with the adjacent features or may have one or more intervening layers.

For clarity, the expression “A and/or B” should be understood to include (A), (B), or (A and B). Likewise, “A, B, and/or C” covers all possible combinations of those elements, including each individually and all together. When ranges are expressed using the term “between,” the range includes the boundary values unless specified otherwise. The notation “A/B/C” should be interpreted to include any of A, B, or C, alone or in combination. Terms presented in the singular should be understood to encompass the plural unless the context dictates otherwise. For example, “a phase-change material” may involve one or more such materials. Similarly, “an insulator material” may refer to one or more insulating substances. The term “insulating,” as well as variations like “insulative” or “insulator,” is used to mean “electrically insulating” unless otherwise noted. Conversely, “conducting” or “conductive” refers to materials that are electrically conductive. For example, the term “insulator material” may denote solid or process-solidified liquid substances that exhibit electrical non-conductivity.

The disclosure may use the terms “in an embodiment” or “in embodiments” to refer to one or more representative examples, which may differ or overlap. Furthermore, terminology such as “comprising,” “including,” or “having” is intended to be inclusive and interchangeable in the context of this disclosure. Spatial descriptors like “top,” “bottom,” “above,” “below,” or “side” are employed merely for ease of explanation and are not meant to limit the disclosed concepts to a particular orientation. Drawings accompanying this disclosure are not necessarily to scale unless expressly stated. Where ordinal labels such as “first,” “second,” or “third” are used, they are intended only to distinguish between similar items and do not indicate any particular sequence or priority unless explicitly stated.

The detailed description references figures that form an integral part of the disclosure and illustrate various embodiments. These are provided for explanatory purposes and do not limit the range of possible implementations. Variations may include structural or logical modifications while remaining within the scope of the invention. For the sake of clarity in the drawings, repetitive elements may not always be individually labeled. Groups of figures sharing the same number but differing by alphabetical suffixes may be referred to collectively without using the alphabetical suffixes (e.g., FIGS. 4A-4B may be referred to as “FIG. 4,” etc.).

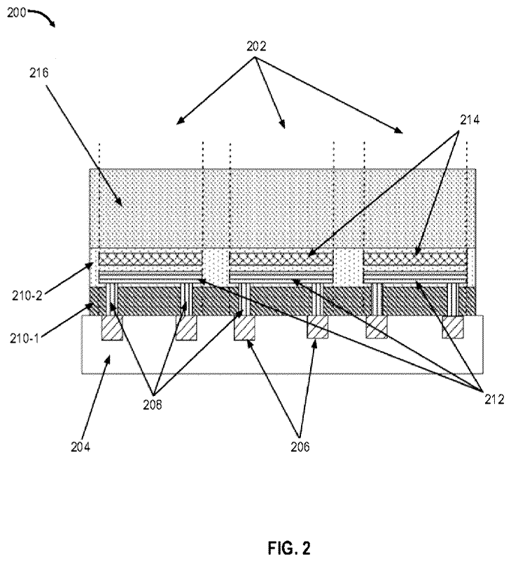

Some drawings may present schematic depictions of devices and assemblies (e.g., light modulation elements shown in FIG. 2), using simplified geometry like straight lines and perfect angles. However, actual fabricated structures may exhibit deviations due to process limitations and defects visible in imaging techniques such as scanning electron microscopy (SEM) or transmission electron microscopy (TEM). These real-world images may reveal imperfections such as irregular edges, tapered vias, rounding of corners, non-uniform thicknesses, and crystalline dislocations, whether at the atomic scale or involving clusters of atoms. Other fabrication-related defects not listed here may also appear and are considered typical within the field. Techniques such as physical failure analysis (PFA), reverse engineering using microscopy, and inspection of layout or mask data may be used to confirm the presence of curved lightguides with SLMs for AR applications described herein.

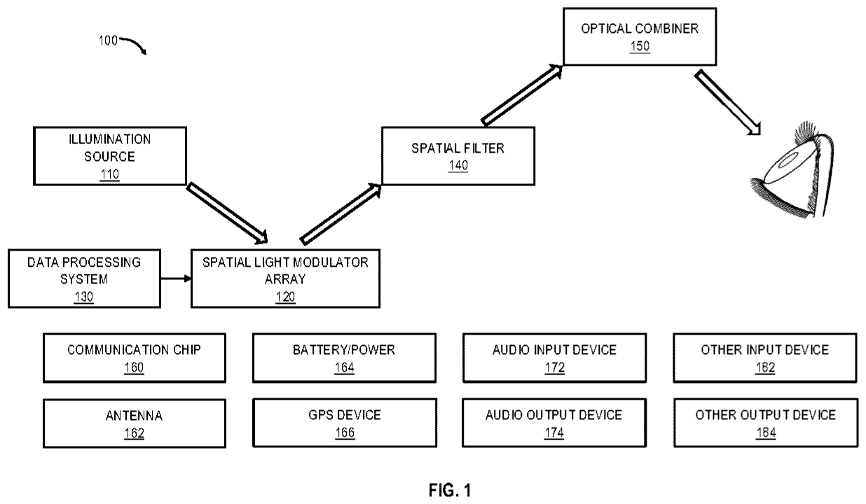

FIG. 1 provides a schematic illustration of a holographic display system 100 in which curved lightguides with SLMs for AR applications may be used (or in other embodiments, in which free-space light engines with SLMs or flat lightguides with SLMs for AR applications may be used), according to some embodiments. As shown in FIG. 1, the holographic display system 100 may provide an illumination source 110, an SLM array 120 (i.e., an array of light modulation elements), a data processing system 130, as well as, optionally, a spatial filter 140 and/or an optical combiner 150. FIG. 1 also schematically illustrates an eye of an observer looking at a reconstructed image rendered by the holographic display system 100.

The illumination source 110 may include one or more components capable of emitting light (e.g., coherent or partially coherent light) suitable for holographic image reconstruction. In particular, the illumination source 110 may be configured to emit light to be incident on the SLM array 120, which may then modulate the incident light to form the holographic reconstructed image. The illumination source 110 may include one or more lasers, laser diodes, or other light sources (e.g., coherent or partially coherent light sources) capable of producing light at discrete wavelengths, such as red, green, and blue, to enable multi-color holographic imaging. In some embodiments, the illumination source 110 may include one or more individual light sources, each emitting a distinct wavelength—for example, one laser for red, another for green, and a third for blue. In alternative embodiments, the illumination source 110 may include a single multi-wavelength light source, e.g., a single multi-wavelength laser, to generate two or more of the wavelengths (e.g., red and green), while additional light sources may be used in case additional wavelengths are desired.

As indicated in FIG. 1, the light beams emitted from the illumination source 110 are directed toward the SLM array 120. The illumination source 110 may further incorporate beam-steering or beam-directing components to control the angle at which each wavelength of light impinges on the SLM array 120. These components may include, but are not limited to, mirrors (e.g., MEMS-based mirrors or dichroic mirrors), optical prisms (e.g., x-cubes), diffraction gratings, metasurfaces, acousto-optic or electro-optic deflectors, or adjustable optical fibers, which can precisely alter the incident angles of the light beams.

The SLM array 120 may include an array of light modulation elements, such as SLM pixels, configured to dynamically encode the holographic patterns received from the data processing system 130. The SLM array 120 is configured to modulate the amplitude and/or phase (and/or the polarization) of the incident light beams provided by the illumination source 110 to create a modulated wavefront corresponding to the hologram pattern provided by the data processing system 130. This wavefront carries the information necessary to reconstruct the target image. One example of the SLM array 120 is shown in FIG. 2; however, in other embodiments, any suitable SLM array may be used in accordance with the descriptions provided herein.

The data processing system 130 may be operatively coupled to the SLM array 120. The data processing system 130 may be configured to receive hologram patterns or to generate hologram patterns based on input data, such as a target image. These patterns may be computed using algorithms that account for the wavelengths emitted by the illumination source 110 and for the angles at which these light beams are incident onto the SLM array 120. The data processing system 130 may be configured to ensure that the hologram patterns are optimized for accurate reconstruction of the target image when the light beams from the illumination source 110 interact with the SLM array 120.

In some embodiments, a spatial filter 140 may be positioned downstream of the SLM array 120. The spatial filter 140 may be configured to selectively block unwanted light components output by the SLM array 120, such as zero-order light, conjugate images, and/or quantization noise, while allowing the desired diffracted light output by the SLM array 120 to pass through. As used herein, the term “zero-order” light refers to the zero-order diffraction of the light output from an SLM, which is typically light reflected from the SLM. Zero-order light may also be referred to as undiffracted light in some cases.

In various implementations, the spatial filter 140 may take the form of a physical aperture, or mask, or it may incorporate more advanced optical elements. In an implementation where the holographic display system 100 includes a 4f optical system, the spatial filter 140 can be in front, at, or behind the Fourier plane of the 4f optical system. In other embodiments of the holographic display system 100, however, the spatial filter 140 may be omitted entirely. For example, the holographic display system 100 may be optically engineered to mitigate the impact of undesired light without needing a dedicated spatial filter. This may be accomplished by limiting the FoV collected by the downstream optical system, such as through careful design of lens apertures or acceptance angles, so that only the intended diffracted orders fall within the system's collection angle, while stray or undesired components fall outside of it. In such cases, the absence of a spatial filter may simplify the system architecture while still achieving acceptable image quality for the intended application.

When the holographic display system 100 is used for AR applications, it may further include an optical combiner 150 configured to receive the light as modulated by the SLM array 120, possibly after said light has been filtered by the spatial filter 140, and to overlay the reconstructed (color) image (e.g., reconstructed color image) with a view of the physical environment. The optical combiner 150 may include one or more optical components, including but not limited to lenses, beam splitters, partially reflective mirrors, prisms, diffraction gratings (e.g., holographic optical elements), metasurfaces (e.g., 2D artificial sheet materials with subwavelength features that can manipulate light), or other light-directing elements. The output from the optical combiner 150 may then be directed toward the observer's eye, enabling visual perception of the reconstructed holographic scene.

When the holographic display system 100 is integrated into an AR platform, the optical combiner 150 may be part of AR display hardware such as AR glasses, headsets, visors, or similar wearable devices. In particular, the optical combiner 150 may include a curved lightguide with transmissive and reflective DOEs on the opposite surfaces (e.g., as illustrated in FIG. 3). The combiner 150 may be designed to overlay the reconstructed virtual image onto the viewer's direct view of the physical environment. This allows the virtual content to be seamlessly superimposed on the real-world scene that the observer is looking at, providing a spatially registered and contextually integrated AR experience.

In some embodiments, the holographic display system 100 may include, or may be communicatively coupled to, one or more of a communication chip 160, an antenna 162, a battery/power circuitry 164, a global positioning system (GPS) device 166, an audio input device 172, an audio output device 174, an other input device 182, or an other output device 184.

The communication chip 160 may be configured for managing wireless communications for the transfer of data to and from the holographic display system 100. The term “wireless” and its derivatives may be used to describe circuits, devices, systems, methods, techniques, communication channels, etc., that may communicate data through the use of modulated electromagnetic radiation through a nonsolid medium. The term does not imply that the associated devices do not contain any wires, although in some embodiments they might not.

The communication chip 160 may implement any of a number of wireless standards or protocols, including but not limited to Institute for Electrical and Electronic Engineers (IEEE) standards, including Wi-Fi (IEEE 802.11 family), IEEE 802.16 standards (e.g., IEEE 802.16-2005 Amendment), Long-Term Evolution (LTE) project, along with any amendments, updates, and/or revisions (e.g., advanced LTE project, ultra-mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication chip 160 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 160 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 160 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 160 may operate in accordance with other wireless protocols in other embodiments. The holographic display system 100 may include an antenna 162 to facilitate wireless communications and/or to receive other wireless communications (such as AM or FM radio transmissions).

In some embodiments, the communication chip 160 may manage wired communications, such as electrical, optical, or any other suitable communication protocols (e.g., Ethernet). In some embodiments, the communication chip 160 may include multiple communication chips. For instance, a first communication chip 160 may be dedicated to shorter-range wireless communications, such as Wi-Fi or Bluetooth, and a second communication chip 160 may be dedicated to longer-range wireless communications, such as GPS, EDGE, GPRS, CDMA, WiMAX, LTE, EV-DO, or others. In some embodiments, a first communication chip 160 may be dedicated to wireless communications, and a second communication chip 160 may be dedicated to wired communications.

In some embodiments, the holographic display system 100 may include a battery/power circuitry 164. The battery/power circuitry 164 may include one or more energy storage devices (e.g., batteries or capacitors) and/or circuitry for coupling components of the holographic display system 100 to an energy source separate from the holographic display system 100 (e.g., AC line power).

In some embodiments, the holographic display system 100 may include a GPS device 166 (or corresponding interface circuitry, as discussed above). The GPS device 166 may be in communication with a satellite-based system and may receive a location of the holographic display system 100, as known in the art.

In some embodiments, the holographic display system 100 may include an audio input device 172 (or a corresponding interface to be connected to said circuitry). The audio input device 172 may include any device that generates a signal representative of a sound, such as microphones, microphone arrays, or digital instruments (e.g., instruments having a musical instrument digital interface (MIDI) output).

In some embodiments, the holographic display system 100 may include an audio output device 174 (or a corresponding interface to be connected to said circuitry). The audio output device 174 may include any device that generates an audible indicator, such as speakers, headsets, or earbuds.

In some embodiments, the holographic display system 100 may include another input device 182 (or a corresponding interface to be connected to said circuitry). Examples of the other input device 182 may include an eye-tracking device, a camera or another image capture device, an accelerometer, a gyroscope, a compass, a keyboard, a cursor control device, such as a mouse, a stylus, a touchpad, a bar code reader, a Quick Response (QR) code reader, any sensor, or a radio frequency identification (RFID) reader.

In some embodiments, the holographic display system 100 may include another output device 184 (or corresponding interface circuitry, as discussed above). Examples of the other output device 184 may include an audio codec, a video codec, a printer, a wired or wireless transmitter for providing information to other devices, or an additional storage device.

The holographic display system 100 may be implemented in any suitable form factor, depending on the intended application and viewer experience. For example, the system may take the form of wearable devices such as AR glasses or other AR display hardware, mixed reality headsets, or VR goggles. These wearable implementations are particularly well-suited for immersive applications where hands-free operation, mobility, and viewer comfort are important.

FIG. 2 provides a cross-sectional side view of an example SLM array 200, according to some embodiments. The SLM array 200 may be one example of the SLM array 120 of FIG. 1. In various examples, light modulation can be described as a process for controlling one or more properties of light, such as amplitude, phase, polarization, or frequency. In an example, a light modulation process can be a static process. In another example, a light modulation process can be a dynamic process. In further examples of implementation and operation, light modulation can include spatial light modulation, where spatial light modulation can be described as a process for changing the spatial distribution of the amplitude, phase, and/or polarization of one or more optical light waves. In another example, spatial light modulation can be described as a process for changing the spatial distribution of the amplitude, phase, and/or polarization of an electromagnetic field. In an example, an SLM can be a two-dimensional array of pixels that can be used to dynamically modulate light in space and time. In various examples, spatial light modulation can be achieved by altering the phase, amplitude, polarization, or any combination thereof of light. In a specific example, an array of tunable pixels can be used to diffract an incoming light beam, enabling the interference of light waves in 3D space. In a related example, an incoming light beam spectrum can be selected such that a projected rendering is substantially within the visible spectrum (wavelength range of 400-700 nm) for observation by humans.

In an example, unit cells 202 may be formed as stacks on a substrate 204, together forming an SLM array 200. Accordingly, a unit cell array can refer to an array of light modulation elements, a light modulation array, or a pixel array. In some embodiments, substrate 204 can be an IC fabricated through, e.g., front-end-of-line (FEOL) processes to form various complementary-metal-oxide-semiconductor (CMOS) elements, interconnects, logic structures, and control structures. In a more specific example, substrate 204 may be fabricated to provide elements configured for electrical connections, such as contact pads 206 for connection to unit cells 202. In an alternative example, contact pads 206 may be formed on substrate 204 as one or more process steps used in the formation of unit cells 202. In an example, contact pads 206 may be adapted to electrically couple substrate 204 to each of the unit cells 202. In yet another example, substrate 204 can include CMOS back-end-of-line (BEOL) elements configured to provide electrical interconnections for CMOS elements and electrical connections to unit cells 202.

In some embodiments, electrical interconnects 208 may be formed on substrate 204 to provide electrical connections between various elements of substrate 204 and elements of unit cells 202. In some embodiments, interconnects 208 may be formed of one or more electrically conductive materials separated by one or more insulating materials (dielectrics), the one or more insulating materials comprising at least a portion of insulator material 210-1, to provide thermal separation and/or electrical isolation between individual elements of unit cells 202 and to provide electrical isolation between electrical interconnects 208. In various examples, each interconnect of interconnects 208 may be adapted to provide an electrical connection at a first end between a contact pad of the contact pads 206 and another element of a unit cell of unit cells 202 at a second end. In an example, insulator material 210-1 is configured to provide electrical isolation between some or all of interconnects 208. Example insulator materials described herein, e.g., any of the insulator material 210-1 or the insulator material 210-2, may include materials such as silicon dioxide, silicon nitride, silicon oxynitride, silicon oxycarbide nitride, or low-k dielectric materials (e.g., materials having a dielectric constant lower than that of silicon). Low-k dielectric materials may include various organic and inorganic low-k materials, such as fluorinated silicon dioxide, organosilicate glass, and porous dielectric materials. Other examples of insulator materials described herein may include high-k dielectric materials (e.g., materials having a dielectric constant higher than that of silicon) that may be advantageous in terms of providing a reduced physical thickness of a given dielectric layer, with examples including hafnium oxide (HfO2), zirconium oxide (ZrO2), and aluminum oxide (Al2O3). Other examples of insulator materials that may be used in the SLM array 200 include organic polymers such as polyimides, borophosphosilicate glass (BPSG), and spin-on glass (SOG).

In an example, insulator material 210-1 can be deposited, patterned, and etched using various photolithography methodologies to provide voids for the formation of interconnects 208 in the voids. In an example, insulator material 210-1 can be provided with voids for the formation of interconnects 208 by depositing conductive materials over insulator material 210-1, such that the conductive material forms a plurality of conducting structures between substrate 204 and other elements of unit cells 202. Example conductive materials include one or more of aluminum, copper alloy, or any other reasonably efficient electrical conductor, but need not comprise a metal material. In a related example, conducting materials can be at least partially removed (using, for example, a planarization process and/or a patterning and etching process) to form interconnects 208 to enable coupling to other elements of unit cells 202. In some embodiments, interconnects 208 can be formed in a plurality of steps, with each interconnect of interconnects 208 comprising additional elements (not shown in the present drawings). In the various examples, the additional elements can be formed using multiple photolithographic operations to provide routing and connectivity between contact pads 206 and various elements of the unit cells 202.

In some embodiments, substrate 204 may include processing circuitry for controlling an electric potential and current flow through each interconnect of interconnects 208, such that arrangements of one or more of the interconnects that comprise interconnects 208 can be controlled independently. In some embodiments, a heater material can be formed over a surface adapted to provide connectivity to at least some of the interconnects of interconnects 208. In the example, heater material can be deposited on the surface over interconnects 208, which can be exposed using one or more etching or planarization processes, enabling coupling for interconnects 208 with the heater material. In a related example, heater material can be patterned to isolate the heater material in each unit cell from adjacent unit cells in order to create heater elements 212, where each heater element of heater elements 212 is associated with a unit cell of unit cells 202. In an example of operation, the SLM array 200 can be adapted to provide substantially independent application of current to each heater element of heater elements 212. In an example of operation, heater elements 212 are configured to receive electrical energy via the plurality of interconnects 208 to thereby induce Joule heating in the heater material. Example heater materials include tantalum nitride (TaN), electrically conductive metal oxide materials or any other material with suitable electrical resistivity. In an example, the stoichiometry of TaN (the ratio of tantalum atoms to nitrogen atoms) can be adjusted to achieve a desired electrical resistance for the heater, while optimizing current and voltage applied to the heater element. In a specific related example, an additional factor defining the heater resistance can be TaN film thickness. In an example, by varying TaN stoichiometry and film thickness, the resistance of a heater element can be adjusted in a range of 1 Ohm-1000 Ohm.

In some embodiments, various materials may be formed over the heater material used to form heater elements 212 in a completed unit cell stack for unit cells 202. In an example, each unit cell stack includes a PCM 214 above the heater material comprising heater elements 212. In various examples, a PCM 214 may be a material having a reversible crystal phase property.

In some embodiments, a phase-change material, such as the PCM 214, can be adapted to thermally interconvert between one or more crystalline and one or more amorphous states on a relatively short time scale using, for example, a temperature pulse from a heat source. In an example, when changing the PCM 214 between amorphous and crystalline states, the refractive index of PCM 214 is changed, so that one or more of amplitude, phase, or polarization of the reflected light can be changed. In an example, once a pulse of temperature concludes, the state of PCM 214 is “locked-in” and remains unchanged absent another thermal interconversion event. In various examples, PCM 214 can be deposited as a thin film atop a dielectric material configured from insulator material 210-2. In some embodiments, deposition techniques for depositing the PCM 214 can include, for example, physical vapor deposition (PVD) with the phase-change material being evaporated from a solid source and then condensed onto the substrate. In other embodiments, the PCM 214 can be deposited using chemical vapor deposition (CVD) with a chemical reaction of gaseous precursors used to form a thin film phase-change material on the surface of insulator material 210-2. Example PCMs include but are not limited to GexSbyTez (Germanium Antimony Tellurium), SbxSy (Antimony Sulfide), SbxSey (Antimony Selenide), and MoxOy (Molybdenum Oxide).

In some embodiments, the insulator material 210-2 may include one or more materials to provide mechanical, electrical, or chemical protection for the PCM 214. In some embodiments, the insulator material 210-2 may be configured as an anti-diffusion material for the PCM 214. In some embodiments, a passivation 216 may be adapted to provide mechanical and/or electrical protection for unit cells 202. In an additional example, the passivation 216 can comprise one or more materials having relatively high thermal insulating properties, including, but not limited to, silicon oxide or titanium oxide.

In some embodiments, the PCM of a unit cell, such as the PCM 214, may be configured to be changeable between two states. In an example, the two states can be a substantially crystalline state as a first state and a substantially amorphous state as a second state. In an alternative example, the PCM of a unit cell may be configured to be changeable between more than two states: a substantially crystalline state, a substantially amorphous state, and one or more additional states between the substantially crystalline state and the substantially amorphous state. As an example, a state being defined as being between a substantially crystalline state and a substantially amorphous state can indicate formation and growth/expansion of one or more crystalline nucleation sites within an amorphous state. In another example, a substantially crystalline state indicates that one or more crystalline nucleation sites have enlarged sufficiently that no more amorphous state remains. In a specific example, multiple states between a substantially crystalline state and a substantially amorphous state can be achieved in practice by intentionally stopping the growth of the one or more crystalline nucleation sites at each of multiple growth stages.

FIG. 3 provides a perspective illustration of AR glasses 300 with an SLM 310 and a curved lightguide 320, according to some embodiments. The AR glasses 300 are one example of an AR display hardware in which the curved lightguide 320 with the SLM 310 may be used; in other embodiments, the curved lightguide 320 with the SLM 310 may be implemented in other types of AR display hardware, such as AR headsets, visors, or similar wearable devices. In some embodiments, the SLM 310 may include the SLM array 120 or the SLM array 200, described above. In some embodiments, the curved lightguide 320 may be an example of the optical combiner 150, described above.

The curved lightguide 320 may be implemented as a lens of the AR glasses 300. FIG. 3 only illustrates a left lens of the AR glasses 300. A right lens may be implemented in a similar manner, e.g., the right lens may be a mirror image of the left lens illustrated in the present drawings. As shown in FIG. 3, the curved lightguide 320 may include a transmissive DOE 322 provided on a portion of the outer surface of the curved lightguide 320 that is closest to the viewer's eyes. Thus, the transmissive DOE 322 may be provided on a portion of the concave outer surface of the curved lightguide 320. As also shown in FIG. 3, the curved lightguide 320 may further include a reflective DOE 324 applied to a portion of the opposite outer surface of the curved lightguide 320 (i.e., the outer surface of the curved lightguide 320 that is farthest from the viewer's eyes). Thus, the reflective DOE 324 may be provided on a portion of the convex outer surface of the curved lightguide 320.

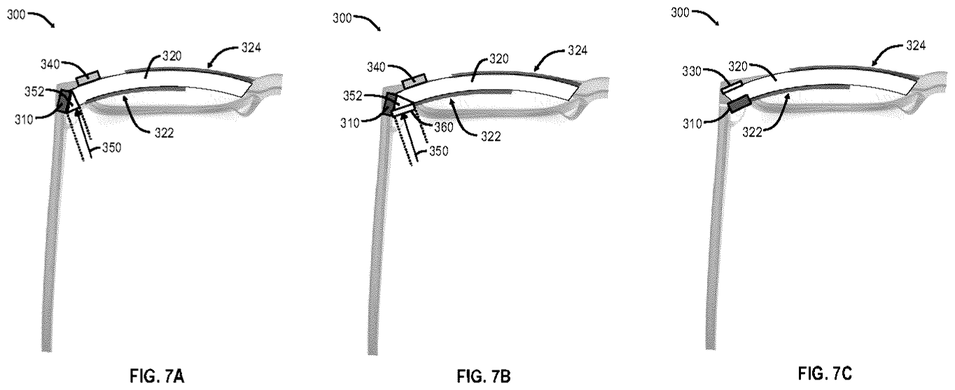

FIG. 3 further illustrates that the SLM 310 may be implemented at or near the temple of the AR glasses 300. In some embodiments, the SLM 310 may be attached to the surface of the curved lightguide 320 near the periphery of the curved lightguide 320. For example, in some embodiments, the SLM 310 may be attached to the convex outer surface of the curved lightguide 320 near the periphery of the curved lightguide 320, as illustrated in FIGS. 3-6, while, in other embodiments, the SLM 310 may be attached to a side surface (or an end) of the curved lightguide 320, as illustrated in FIGS. 7A and 7B. In still other embodiments, the SLM 310 may be attached to the concave outer surface of the curved lightguide 320, as illustrated in FIG. 7C. Modulated light emerging from the SLM 310 may be incoupled into the curved lightguide 320. Some portions of that light may be incident on the transmissive DOE 322, while other portions of that light may be incident on the reflective DOE 324. Each of the transmissive DOE 322 and the reflective DOE 324 may include a respective volume hologram or metasurface configured to, respectively, transmit and reflect some of the modulated light incident thereon. In some embodiments, one of the transmissive DOE 322 and the reflective DOE 324 may be a volume hologram and another one may be a metasurface. In some embodiments, the transmissive DOE 322 and the reflective DOE 324 may include wavelength-selective and incident angle-selective volume holograms or metasurfaces. In some implementations, the transmissive DOE 322 and the reflective DOE 324 may partially overlap in their spatial coverage, as illustrated in the example shown in FIG. 3. In other implementations, the transmissive DOE 322 and the reflective DOE 324 may not overlap in their spatial coverage, as illustrated in the example shown in FIGS. 4A and 4B.

In various embodiments, any of the transmissive DOE 322 and the reflective DOE 324 may include a single volume hologram or metasurface or a stack of volume holograms or metasurfaces, where each volume hologram or metasurface can be configured for operation at a single wavelength or for operation with two or more wavelengths. In some embodiments, one or both of the transmissive DOE 322 and the reflective DOE 324 may include a stack of three volume holograms or metasurfaces, where a first volume hologram or metasurface of the stack is configured for operation at a red wavelength, a second volume hologram or metasurface (different from the first volume hologram or metasurface) of the stack is configured for operation at a green wavelength, and a third volume hologram or metasurface (different from the first and the second volume holograms or metasurfaces) of the stack is configured for operation at a blue wavelength. An inset 370 shown in FIG. 3 illustrates a cross-sectional side view of a portion of an DOE 372 which may be either the transmissive DOE 322 or the reflective DOE 324 and includes a stack of three layers 374 of volume holograms or metasurfaces, individually labeled as layers 374-1, 374-2, and 374-3, where each of the layers 374 may be a layer of a volume hologram or a metasurface. In yet other embodiments, one or both of the transmissive DOE 322 and the reflective DOE 324 may include a single volume hologram or metasurface configured for operation at red, green, and blue wavelengths.

In some embodiments, the curved lightguide 320 may include any suitable materials, such as glass and/or polymer materials. In some embodiments, the thickness of the curved lightguide 320 may be between about 1 millimeter (mm) and 30 mm, e.g., between about 1 mm and 10 mm. In some embodiments, the transmissive DOE 322 (e.g., when the DOE is implemented as an HOE) may include any suitable materials, such as photopolymers, silver halides, photo-thermo-refractive (PTR) glass, thermoplastics (e.g., Polymethyl methacrylate or PQ:PMMA), and dichromated gelatine (DCG). In some embodiments, the thickness of the transmissive DOE 322 (e.g., when the DOE is implemented as an HOE) may be at least about 5 μm, e.g., between about 500 μm and 30 mm, e.g., between about 1 mm and 10 mm or between about 1 mm and 3 mm. In some embodiments, the reflective DOE 324 (e.g., when the DOE is implemented as an HOE) may include any suitable materials, such as photopolymers, silver halides, PTR glass, thermoplastics (e.g., Polymethyl methacrylate or PQ:PMMA), and dichromated gelatine (DCG). In some embodiments, the thickness of the reflective DOE 324 (e.g., when the DOE is implemented as an HOE) may be at least about 5 μm, e.g., between about 500 μm and 30 mm, e.g., between about 1 mm and 3 mm, between about 1 mm and 10 mm.

In some embodiments, PTR glass may be used to form the DOEs (e.g., when one or more of the DOEs is implemented as an HOE) as described herein, as it may offer exceptionally high Bragg selectivity compared to alternative materials. PTR glass may be exposed using ultraviolet (UV) light to record the interference pattern. Unlike photopolymer materials, which can be patterned in a single exposure, PTR glass may be processed in a step-and-repeat exposure process due to the high optical power needed for recording. In this process, the hologram is written incrementally in discrete regions referred to as “hogels” (holographic elements), each corresponding to a small write area (e.g., approximately 0.5 mm×0.5 mm). Thousands of hogels may be sequentially exposed to form the complete volume hologram. This hogel-by-hogel approach may enable precise control of the recorded pattern and support the creation of a large-area volume hologram with complex functionalities. The use of PTR glass and the associated fabrication processes may allow the resulting volume hologram to achieve superior optical performance, including high diffraction efficiency, minimal crosstalk, and robust environmental stability. In some embodiments, the thickness of the volume hologram may be between about 1 mm and 2 mm.

Although not specifically shown in the present drawings, in various embodiments, one or more additional layers may be present between the curved lightguide 320 and the transmissive DOE 322, and/or one or more additional layers may be present between the curved lightguide 320 and the reflective DOE 324. Such layers may include, e.g., an index-matching layer and/or an optical adhesive layer. However, descriptions with respect to the TIR and the modulated light outcoupled by the transmissive DOE 322 and the reflective DOE 324 still hold even if such additional layers are present.

FIGS. 4A and 4B provide top views of a curved lightguide 320 with an SLM 310 (which may be included in the AR glasses 300 as described herein), illustrating a FoV delivered by, respectively, a transmissive DOE and a reflective DOE, according to some embodiments. In particular, FIG. 4A illustrates that a first portion 332 of the modulated light from the SLM 310 may be incident on the transmissive DOE 322. The transmissive DOE 322 may be configured to outcouple a portion of the modulated light incident thereon to deliver a first FoV (labeled as “FoV1” and also labeled as first outcoupled modulated light 342 in FIG. 4A) to the viewer's eye. Similarly, FIG. 4A illustrates that a second portion 334 of the modulated light from the SLM 310 may be incident on the reflective DOE 324. The reflective DOE 324 may be configured to outcouple a portion of the modulated light incident thereon to deliver a second FoV (labeled as “FoV2” and also labeled as second outcoupled modulated light 344 in FIG. 4B) to the viewer's eye. Because the transmissive DOE 322 and the reflective DOE 324 deliver different portions of the FoV to the viewer, together, their FoVs add so that a complete image may be reconstructed from the first outcoupled modulated light 342 and the second outcoupled modulated light 344.

It should be noted that portions of the modulated light from the SLM 310 that are outcoupled from the lightguide 320, such as the first outcoupled modulated light 342 and the second outcoupled modulated light 344, do not propagate through the curved lightguide 320 via TIR prior to being outcoupled. As is known, TIR is a phenomenon that takes place at an interface of two materials with different refractive indices. The modulated light from the SLM 310 that is outcoupled from the lightguide 320 by the transmissive DOE 322 and the reflective DOE 324 is light that is not subject to TIR within the curved lightguide 320. Specifically, the first outcoupled modulated light 342 does not propagate through the curved lightguide 320 at all. This is because the transmissive DOE 322 is positioned at the concave side of the curved lightguide, which corresponds with the side of the curved lightguide at which light is outcoupled. Therefore, when the first portion 332 of the modulated light from the SLM 310 reaches the transmissive DOE 322, it is directly outcoupled by the transmissive DOE 322. The transmissive DOE 322 has a first surface and a second surface, where the first surface is the surface closest to the concave side of the curved lightguide and the second surface is opposite to the first surface. The modulated light from the SLM 310 is incident on the first surface of the transmissive DOE 322 and is outcoupled at the second surface of the transmissive DOE 322. In an embodiment of AR glasses 300, light is outcoupled at the concave side of the curved lightguide 320 and directed to the eye of a viewer. In contrast to the first outcoupled modulated light 342, the second outcoupled modulated light 344 does propagate through the curved lightguide 320 after being reflected (e.g., diffracted) by the reflective DOE 324. However, as it travels from the convex surface of the curved lightguide 320 toward the concave surface, it does so without undergoing TIR. Instead, the propagation of the second outcoupled modulated light 344 is governed by reflection from the reflective DOE 324 and controlled by the geometry of the curved lightguide 320 and the positioning of the reflective DOE 324. In various implementations, the absence of TIR for these outcoupled beams may be advantageous for reducing optical path length, minimizing distortion, and enabling precise control of the exit angle.

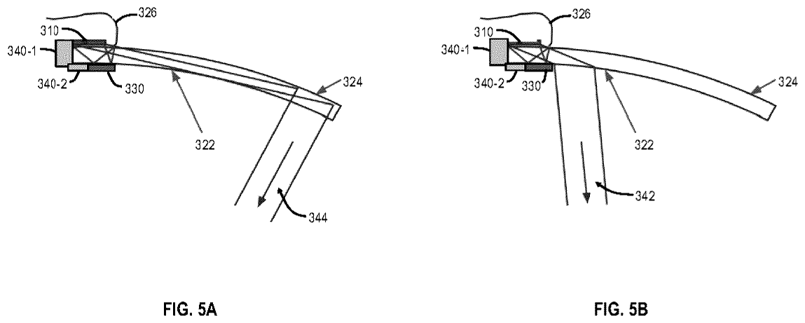

FIGS. 5A and 5B provide top views of a curved lightguide 320 with an SLM 310 (which may be included in the AR glasses 300 as described herein), illustrating light beams incident on, respectively, a reflective DOE 324 and a transmissive DOE 322, when an illumination source (e.g., an optical fiber) is coupled to a convex surface of the curved lightguide, according to some embodiments. As shown in FIGS. 5A and 5B, portions of the modulated light from the SLM 310 that are incident on the reflective DOE 324 and the transmissive DOE 322 do not propagate through the curved lightguide 320 via TIR before being outcoupled. Instead, the transmissive DOE 322 and the reflective DOE 324 are designed and placed on the curved lightguide 320 so that, once a light ray of the modulated light emerging from the SLM 310 reaches an interior surface of the curved lightguide 320 for the first time, it will directly reach either the reflective DOE 324 (FIG. 5A) or the transmissive DOE 322 (FIG. 5B). A portion of the modulated light reaching the transmissive DOE 322 (e.g., the first portion 332 of the modulated light from the SLM 310 in FIGS. 4A and 4B) will exit the lightguide as the first outcoupled modulated light 342 and be directed to the viewer's eye. Because the reflective DOE 324 is located on the outward-facing surface of the curved lightguide 320 (i.e., the outer surface opposite the viewer's eye), a portion of the modulated light reaching the reflective DOE 324 (e.g., the second portion 334 of the modulated light from the SLM 310 in FIGS. 4A and 4B) is reflected by the reflective DOE 324 back through a portion of the curved lightguide 320 toward the eye, where it then exits the lightguide as the second outcoupled modulated light 344 and is perceived by the viewer. Thus, because the reflective DOE 324 is applied at the outer surface of the curved lightguide 320 opposite the side of the viewer's eye, light rays reaching the reflective DOE 324 are reflected to the viewer's eye and therefore still need to travel through a small portion of the curved lightguide 320 before exiting the curved lightguide 320. Because the transmissive DOE 322 is applied at the outer surface of the curved lightguide 320 at the side that is closest to the viewer's eye, light rays reaching the transmissive DOE 322 are transmitted by the transmissive DOE 322 towards the viewer's eye and therefore do not need to travel through any portion of the curved lightguide 320 before exiting the curved lightguide 320 as the first outcoupled modulated light 342.

FIGS. 5A-5B further illustrate an optical fiber 326 that may be coupled to one of the surfaces of the curved lightguide 320 to provide light to illuminate the SLM 310. The light entering the curved lightguide 320 from the optical fiber 326 may be referred to as a “playback light” because this light is used to illuminate the pixels of the SLM 310 to perform the “playback” in terms of reconstructing the holograms of the SLM 310.

FIGS. 5A-5B illustrate an example where both the optical fiber 326 is coupled to the convex surface of the curved lightguide 320 and the SLM 310 is attached to the convex surface of the curved lightguide 320. In such embodiments, a reflective element 330 (e.g., a mirror, a diffraction grating, an HOE, or a metasurface) may be provided on a portion of the opposite surface of the curved lightguide 320 (e.g., on a portion of the concave surface) to reflect the light from the optical fiber 326 onto the SLM 310 in order to illuminate the SLM 310. In some embodiments, one or more optical elements may be positioned in between the optical fiber 326 and the convex surface of the curved lightguide (e.g., curved lightguide 320 in FIG. 3). Such one or more optical elements may be configured to diverge, collimate, or converge the light beam of the optical fiber 326.

FIGS. 5A-5B further illustrate that, in some embodiments, one or more absorbers 340 (individually labeled in each of FIGS. 5A-5B as absorbers 340-1 and 340-2) that may be provided on one or more surfaces of the curved lightguide 320 to capture and dissipate residual light energy without introducing unwanted reflections or scattering. For example, in some embodiments, the one or more absorbers 340 may be configured to capture and dissipate at least some of the zero-order light output by the SLM 310. In some embodiments, the one or more absorbers 340 may be configured to capture and dissipate at least some of the light reflected by the reflective element 330 but being outside of the surface of the SLM 310. FIGS. 5A-5B illustrate that the absorber 340-1 may be provided on a side surface (i.e., at an end) of the curved lightguide 320, while the absorber 340-2 may be provided on the same surface of the curved lightguide 320 as the reflective element 330. In other embodiments, one or both of the absorbers 340-1 and 340-2 may be absent.

When present, the one or more absorbers 340 may be implemented using any suitable light-absorbing structure or material designed to capture and dissipate residual light energy without introducing unwanted reflections or scattering. For example, the one or more absorbers 340 may include a matte black coating with low reflectivity, a carbon-loaded polymer layer, or a microstructured surface engineered to trap light through multiple internal reflections. In some embodiments, the one or more absorbers 340 may incorporate a heat-dissipating substrate or thermal sink to manage the absorbed optical power and prevent localized heating. Alternatively, the one or more absorbers 340 may be realized as an optical dump cavity lined with absorptive material, ensuring that stray light is effectively removed from the optical path. These implementations help maintain image quality by preventing residual playback light and/or zero-order light from interfering with the reconstructed hologram or causing glare within the display system. In some alternative embodiments, the one or more absorbers 340 may be implemented as one or more photodetectors. In some related embodiments, some amount of light reaching the photodetectors may be reflected at the top surface of these photodetectors. Therefore, one or more optical elements may be added to direct the zero-order light to one or more photodetectors, but to avoid that the reflection of the zero-order light at the top surface of the photodetectors is fed back into the curved lightguide 320. In various embodiments, photodetectors implemented in the one or more absorbers 340 may include photodiodes, including PN, PIN, and avalanche photodiodes (APDs). In other embodiments, photodetectors implemented in the one or more absorbers 340 may include photoconductors, Schottky photodiodes, or metal-semiconductor-metal (MSM) detectors.

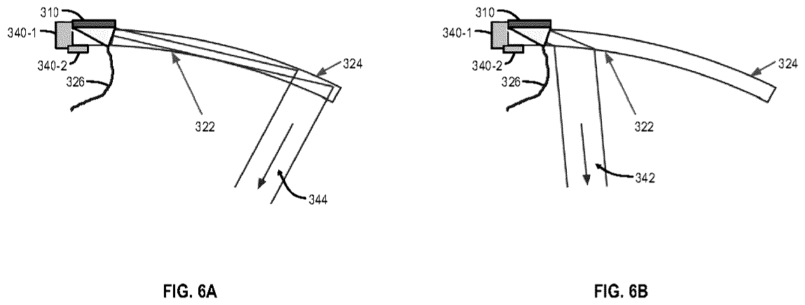

FIGS. 6A and 6B provide top views of a curved lightguide 320 with an SLM 310 (which may be included in the AR glasses 300 as described herein), illustrating light beams incident on, respectively, a reflective DOE and a transmissive DOE, when an optical fiber is coupled to a concave surface of the curved lightguide, according to some embodiments. FIGS. 6A-6B are similar to FIGS. 5A-5B except that the optical fiber 326 is coupled to the concave surface of the curved lightguide 320. In such embodiments, there is no need for a reflective element 330 because the optical fiber 326 is positioned to directly illuminate the SLM 310. In some embodiments, one or more optical elements may be positioned in between the optical fiber 326 and the concave surface of the curved lightguide (e.g., curved lightguide 320 in FIG. 3). Such one or more optical elements may be configured to diverge, collimate, or converge the light beam of the optical fiber 326.

In FIGS. 3-6, the AR glasses 300 are such that the SLM 310 is positioned on the convex surface of the curved lightguide 320. This may be different in other embodiments, as shown in FIGS. 7A-7C. FIGS. 7A and 7B provide a perspective illustration of AR glasses 300 with an SLM 310 and a curved lightguide 320 as in FIG. 3, except that the SLM 310 is positioned on a side surface of the curved lightguide 320, according to some embodiments. FIG. 7C provides a perspective illustration of AR glasses 300 with an SLM 310 and a curved lightguide 320 as in FIG. 3, except that the SLM 310 is positioned on the concave surface of the curved lightguide 320, according to some embodiments.

As shown in FIG. 7A, the SLM 310 is not positioned on the convex or the concave surface of the curved lightguide 320 but, instead, is positioned on a side surface that is between the convex and the concave surface of the curved lightguide 320, e.g., close to the temple of the AR glasses 300. FIG. 7A further illustrates, as an example, a direction 350 of the playback light to be incident on the SLM 310 in such an embodiment, as well as an absorber 340 that may be placed on the convex surface of the curved lightguide 320 in such an embodiment. In some embodiments, as shown in FIG. 7A, the side surface of the curved lightguide 320 on which the SLM 310 is provided may be slanted in that an angle between the side surface and a tangential line to either the convex surface or the concave surface of the curved lightguide 320 is not 90 degrees.

FIG. 7A illustrates an embodiment in which the playback light traveling along the direction 350 toward the curved lightguide 320 is substantially collimated. Upon entering the curved lightguide 320, the playback light that is now inside the curved lightguide 320 is labeled in FIG. 7A as a playback light 352. As shown in FIG. 7A, the playback light 352 may remain largely collimated as it propagates within the curved lightguide 320 and becomes incident on the SLM 310. In contrast, FIG. 7B illustrates a similar embodiment, except that an optical element 360 is positioned in the path of the playback light traveling along direction 350 toward the curved lightguide 320. The optical element 360 converts the collimated light into converging light, such that the playback light 352 within the curved lightguide 320 is a converging beam when incident on the SLM 310.

In various embodiments, the optical element 360 may include any suitable structure for converting substantially collimated light to converging light. Examples include a refractive lens (such as a plano-convex or aspheric lens), a diffractive optical element, a Fresnel lens, or an HOE configured to impart the desired convergence. In some implementations, the optical element 360 may be integrated with the curved lightguide 320 or positioned externally along the optical path to achieve a controlled focal point or area on the SLM 310. The choice of optical element 360 may depend on factors such as available space, desired convergence angle, and wavelength compatibility.

In FIGS. 7A and 7B, the angle between the side surface of the curved lightguide 320 on which SLM 310 is positioned and a one-sided tangential line of the convex surface at the crossing point with the side surface is larger than 90 degrees, and the absorber 340 is positioned on the convex surface of the curved lightguide 320. In some alternative embodiments, the side surface of the curved lightguide 320 on which SLM 310 is positioned may be slanted such that the angle between the side surface and the one-sided tangential line of the convex surface at the crossing point with the side surface is smaller than 90 degrees. For those embodiments, the absorber 340 may be positioned on the concave surface of the curved lightguide 320.

As shown in FIG. 7C, the SLM 310 is not positioned on the convex surface of the curved lightguide 320 but, instead, is positioned on the concave surface. In some related embodiments, a reflective element (e.g., the reflective element 330) may be positioned on the convex surface of the curved lightguide 320 to direct modulated light output by the SLM 310 towards the transmissive DOE 322 and the reflective DOE 324 as described above (e.g., as shown in FIGS. 4A-4B). In other embodiments, such a reflective element may be absent. In general, any suitable means for directing modulated light from the SLM 310 arranged on the concave surface of the curved lightguide 320 onto the transmissive DOE 322 and the reflective DOE 324 is within the scope of the present disclosure.

In some embodiments, a flat lightguide might be preferable over a curved lightguide because the manufacturing process of a flat lightguide might be less complex, faster, and/or cheaper compared to the manufacturing process of a curved lightguide. FIG. 8 illustrates a top view of a left side of example AR glasses 810 comprising a free-space light engine, composed of an optical submodule 820 and a flat DOE 850. In some embodiments, the flat DOE 850 is implemented as a volume hologram (e.g., an HOE). In yet other embodiments, the flat DOE 850 is implemented as a metasurface. In some embodiments, AR glasses 810 are configured to display monochromatic images in front of a viewer's eye 800 overlaid on top of the real-world view of the environment around the viewer. In other embodiments, AR glasses 810 are configured to display polychromatic images (e.g., RGB images) in front of a viewer's eye 800 overlaid on top of the real-world view of the environment around the viewer. The free-space light engine comprises an optical submodule 820 and a flat DOE 850. The optical submodule 820 comprises an SLM (for example, the SLM array 200 as depicted in FIG. 2) and an illumination source (for example, illumination source 110 in FIG. 1, or optical fiber 326 in FIGS. 5 and 6) (both the SLM and the illumination source are not shown in FIG. 8). The free-space light engine of AR glasses 810 is configured to relay an (magnified) image of the SLM top surface (an image at the SLM plane) to a position in front of the viewer's eye 800. The illumination source of the optical submodule 820 provides illumination to the SLM, which may include coherent or partially coherent light. In addition, the illumination source may provide illumination of a single discrete wavelength or of a set of discrete wavelengths (such as red, green, and blue for the generation of RGB images). The SLM contained in the optical submodule 820 modulates the amplitude, phase, and/or polarization of the light received from the illumination source, generating modulated light. The modulated light then exits the optical submodule 820 (e.g., through an opening in the enclosure of the optical submodule 820) forming a modulated light beam 830 in a direction towards the flat DOE 850. In some embodiments, the optical submodule 820 comprises additional optical components in addition to the SLM and the illumination source. These additional optical components can be positioned in the path between the illumination source and the SLM and/or in the path between the SLM and the opening through which the modulated light exits the optical submodule 820, and may include, but are not limited to, lenses, mirrors, metasurfaces, diffractive optical elements, holographic optical elements (in addition to the flat DOE 850), filters (including optical filters and/or spatial filters), and prisms. The optical components positioned in the path between the illumination source and the SLM may be configured to include one or a combination of the following functions: converting the light beam received from the illumination source into a converging, collimated, or diverging light beam; directing light received from the illumination source to only desired subregions of the SLM top surface; illuminating different subregions of the SLM top surface with a different wavelength. The optical components in the path between the SLM and the opening through which the modulated light exits the optical submodule 820 may be configured to assist in one or a combination of the following functions: steering the modulated light in a direction of the flat DOE 850; relaying an image at the SLM top surface (at the plane of the SLM) to a position in front of the viewer's eye 800, resulting in a relayed image; (de)magnifying the relayed image; filtering out unwanted signals (including the zero-order diffraction of light, as resulting from illuminating the SLM; and/or quantization noise, introduced by quantizing a continuous hologram into a quantized hologram that is to be rendered on the SLM). The optical elements in the path between the SLM and the opening of the optical submodule 820 may form, together with the flat DOE 850, a 4f optical system that relays (and in some embodiments also (de)magnifies) the image at the SLM plane (top surface of the SLM) to a plane in front of the viewer's eye 800. In some embodiments, a spatial filter (such as spatial filter 140 as depicted in FIG. 1) may be positioned at the Fourier plane of the 4f optical system to filter out unwanted signals, such as the zero-order diffraction of light, and/or quantization noise. In alternative embodiments, a spatial filter (such as spatial filter 140 depicted in FIG. 1) may be positioned in front of or behind the Fourier plane of a 4f optical system, composed of optical components arranged along an optical path between the SLM and an opening of the optical submodule 820, and the flat DOE 850. The modulated light beam 830 travels in free-space (e.g., through air) towards the flat DOE 850. In some embodiments, the flat DOE 850 is a flat volume hologram (e.g., a flat HOE) or a flat metasurface configured to operate as a reflective DOE. When the modulated light beam 830 reaches the flat DOE 850, light rays of the modulated light beam 830 will be reflected by the flat DOE 850 towards the viewer's eye 800. The light rays of the modulated light beam 830 as reflected by the flat DOE 850 are shown in FIG. 8 as reflected light rays 840. In some embodiments, the flat DOE 850 is configured to reflect only light rays of the modulated light beam 830 having certain predetermined combinations of wavelength and angle of incidence on the flat DOE 850 (the allowed combinations) (e.g., due to the Bragg selectivity of the one or more volume holograms (e.g., one or more HOEs)). Light rays incident on the flat DOE 850 that exhibit a combination of wavelength and angle of incidence different from the allowed combinations will not be reflected to the viewer's eye 800 but will just travel through the flat DOE 850. Additionally, in some embodiments, the flat DOE 850 may be configured to also correct for aberrations introduced by other optical components of the free-space light engine. The flat DOE 850 is configured to be part of the eyeglass lens of AR glasses 810. In some embodiments, the flat DOE 850 is applied to one of the outer surfaces of the eyeglass lens; on the outer surface of the eyeglass lens closest to the viewer's eye 800 or on the outer surface of the eyeglass lens that is opposite to the surface that is closest to the viewer's eye 800. In other embodiments, the flat DOE 850 is positioned inside the eyeglass lens of AR glasses 810. In some embodiments, the flat DOE 850 may comprise a single volume hologram or metasurface which is configured for operation at a single wavelength (for example, a wavelength associated with the color green). In alternative embodiments, the flat DOE 850 may comprise a single volume hologram or metasurface configured for operation at a set of two or more wavelengths. For example, the flat DOE 850 may be configured for operation with red, green, and blue light in a single volume hologram or metasurface. In other embodiments, the DOE 850 comprises a stack of two or more volume holograms or metasurfaces whereby each volume hologram or metasurface is configured to operate at a single wavelength, different from the wavelengths associated with the other volume holograms or metasurfaces in the stack. In yet other embodiments, one or more volume holograms or metasurfaces of the stack may be configured to operate at two or more wavelengths. For example, the flat DOE 850 may comprise a stack of two volume holograms or metasurfaces, where a first volume hologram or metasurface is configured for operation with red and green light and a second volume hologram or metasurface is configured for operation with blue light. The flat DOE 850 may be composed of one or a combination of the following materials: photopolymers, silver halides, PTR glass, thermoplastics (e.g., Polymethyl methacrylate or PQ:PMMA), and dichromated gelatine (DCG). In some embodiments, a thickness of the flat DOE 850 may be at least about 5 μm, e.g., between about 500 μm and 30 mm, e.g., between about 1 mm and 3 mm, between about 1 mm and 10 mm.

FIG. 9 illustrates a top view of a left side of another example of AR glasses 810 comprising a free-space light engine, composed of an optical submodule 820 and a curved DOE 860. In some embodiments, the curved DOE 860 is implemented as a volume hologram (e.g., an HOE). In yet other embodiments, the curved DOE 860 is implemented as a metasurface. As explained in relation to FIG. 8, the flat DOE 850 may be applied to one of the outer surfaces of the eyeglass lens, and because the DOE 850 is flat, that means that the surface to which the flat DOE 850 is applied is also flat. However, it is very uncommon in modern eyewear that one of the two outer surfaces of the eyeglass lens is flat, resulting in aesthetically unappealing-looking eyewear and might even lead to a thicker eyeglass lens in case the eyeglass lens needs to accommodate a viewer's prescription (the eyeglass lens needs to provide the prescribed optical correction). As such, the DOE 860 being curved may result in a thinner eyeglass lens and aesthetically more appealing AR glasses 810. Nonetheless, the purpose of the curved DOE 860 is the same as that of the flat DOE 850, namely to reflect, toward the viewer's eye 800, a set of rays of the modulated light beam 830 that exhibit a wavelength and an angle of incidence on the curved DOE 860 corresponding to one of the allowed combinations, while allowing other rays having a wavelength and an angle of incidence that do not correspond to any of the allowed combinations to pass through. Similar to the flat DOE 850 in FIG. 8, the curved DOE 860 in FIG. 9 may comprise a single volume hologram or metasurface or a stack of volume holograms or metasurfaces, whereby each volume hologram or metasurface can be configured for operation at a single wavelength or for operation with two or more wavelengths. The eyeglass lens of AR glasses 810 exhibits two outer surfaces: a first outer surface closest to the viewer's eye 800 and a second outer surface opposite the outer surface closest to the viewer's eye 800. In some embodiments, the first outer surface is a concave surface. In some related embodiments, the second outer surface is a convex surface. The curvature of one or both surfaces of the eyeglass lens can be configured to accommodate the viewer's eyewear prescription. In some embodiments, the curved DOE 860 may be applied to the first outer surface of the eyeglass lens whereby the curved DOE 860 follows the curvature of the first surface. In alternative embodiments, the curved DOE 860 may be applied to the second outer surface of the eyeglass lens whereby the curved DOE 860 follows the curvature of the second outer surface. In yet other embodiments, the curved DOE 860 may be positioned inside the eyeglass lens of AR glasses 810. The curved DOE 860 may be composed of one or a combination of the following materials: photopolymers, silver halides, PTR glass, thermoplastics (e.g., Polymethyl methacrylate or PQ:PMMA), and dichromated gelatine (DCG). In some embodiments, a thickness of the curved DOE 860 may be at least about 5 μm, e.g., between about 500 μm and 30 mm, e.g., between about 1 mm and 3 mm, between about 1 mm and 10 mm.

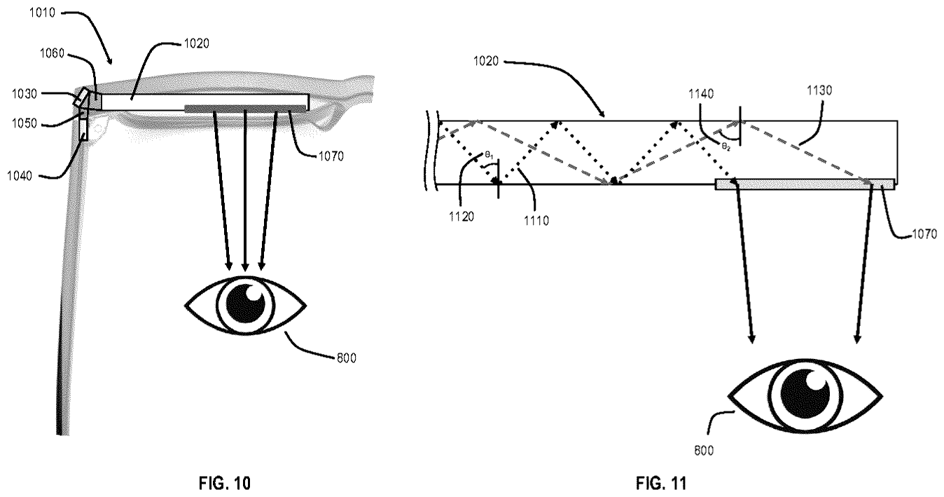

FIG. 10 illustrates a top view of a left side of example AR glasses 1010 with a flat lightguide 1020 comprising a transmissive DOE 1070. In some embodiments, the transmissive DOE 1070 is implemented as a volume hologram (e.g., an HOE). In yet other embodiments, the transmissive DOE 1070 is implemented as a metasurface. AR glasses 1010 further comprise an SLM 1030 (for example, the SLM array 200 as depicted in FIG. 2) and an illumination source 1040 (for example, illumination source 110 in FIG. 1, or optical fiber 326 in FIGS. 5 and 6), whereby the illumination source 1040 provides an illumination beam 1050 to the SLM 1030. The illumination source 1040 may provide light of a single wavelength or light of a set of wavelengths (for example, red, green, and blue light for the generation of RGB images). In some embodiments, the illumination source 1040 may comprise a single discrete component, whereby the single discrete component can deliver a single wavelength or a set of wavelengths. For example, the illumination source 1040 may comprise a single RGB laser (for the generation of RGB images). In alternative embodiments, the illumination source 1040 comprises two or more discrete components, with each discrete component providing light of one or more wavelengths, with the one or more wavelengths being different from the one or more wavelengths provided by each of the other discrete components. For example, the illumination source 1040 may comprise a first discrete component that provides red and green light and a second discrete component that provides blue light. The SLM 1030 modulates the amplitude, phase, and/or polarization of the illumination beam 1050 received from the illumination source 1040, resulting in a modulated light beam 1060, whereby the modulated light beam 1060 is subsequently coupled into the flat lightguide 1020. The area on the flat lightguide 1020 where the modulated light beam 1060 is incoupled can be referred to as the incoupling area. The incoupling area of the flat lightguide 1020 can be positioned on one of the outer edges of the flat lightguide 1020, or on one of the outer surfaces of the flat lightguide 1020. The SLM 1030 and the illumination source 1040 are positioned inside the frame of AR glasses 1010. In some embodiments, one or both of the SLM 1030 and the illumination source 1040 are positioned inside a temple of AR glasses 1010. In alternative embodiments, one or both of the SLM 1030 and the illumination source 1040 are positioned inside a frame front of AR glasses 1010. In yet other embodiments, one or both of the SLM 1030 and the illumination source 1040 are positioned inside a hinge of AR glasses 1010. Furthermore, the outer edges of the flat lightguide 1020 are also enclosed by the frame of AR glasses 1010, more specifically by the frame front of AR glasses 1010. The path that the modulated light beam 1060 travels from the SLM 1030 to the incoupling area of the flat lightguide 1020 is also enclosed by the frame (and in some cases also by the hinge) of AR glasses 1010 (this is in contrast to the AR glasses 810 comprising a free-space light engine, whereby the modulated light beam 830 travels in free space). Due to the fact that the path of the modulated light beam 1060 is enclosed by the frame (and in some cases also by the hinge) of AR glasses 1010 means that the path cannot be obstructed by any elements external to the AR glasses 1010, such as dust or eyelashes, when using AR glasses 1010. Same as explained with FIG. 8, additional optical components may be positioned in the path between the illumination source 1040 and the SLM 1030, as well as additional optical components may be positioned in the path between the SLM 1030 and the incoupling area of the flat lightguide 1020. In some embodiments, the incoupling area may comprise one or a combination of a diffraction grating (e.g., a surface-relief diffraction grating and/or a volume holographic grating) and/or a prism to facilitate the incoupling of the modulated light beam 1060 into the flat lightguide 1020. The incoupling of the modulated light beam 1060 into the flat lightguide 1020 is configured for one or more light rays of the modulated light beam to travel inside the flat lightguide 1020 under TIR from the side of the flat lightguide 1020 where the modulated light beam 1060 was incoupled to the opposite side of the flat lightguide 1020. With other words, the incoupling of the modulated light beam 1060 into the lightguide 1020 is configured such that for the light rays traveling inside the lightguide 1020 the angle of incidence at the interface between the material of the flat lightguide 1020 and the medium by which the flat lightguide 1020 is enclosed is larger than the critical angle for TIR inside the flat lightguide 1020, which is determined by the refractive index of the material of the flat lightguide 1020 and the refractive index of the medium by which the flat lightguide 1020 is enclosed. The flat lightguide 1020 further comprises a transmissive DOE 1070. In some embodiments, the transmissive DOE 1070 comprises a volume hologram (e.g., an HOE) or metasurface. The light rays traveling through the flat lightguide 1020 are, when reaching the transmissive DOE 1070, outcoupled by the transmissive DOE 1070 towards the viewer's eye 800. FIG. 11 illustrates a close-up cross-sectional top view of a portion of the flat lightguide 1020 showing two TIR rays traveling inside the flat lightguide 1020; a first TIR ray 1110 is depicted in FIG. 11 as a dotted line and a second TIR ray 1130 is depicted in FIG. 11 as a dashed line. The angle of incidence of the first TIR ray 1110 inside the flat lightguide 1020 at the interface between the material of the flat lightguide 1020 and the medium by which the flat lightguide 1020 is enclosed is equal to θ₁ (indicated by reference number 1120 in FIG. 11) and the angle of incidence of the second TIR ray 1130 inside the flat lightguide 1020 at the interface of the material of the flat lightguide 1020 and the medium by which the flat lightguide 1020 is enclosed is equal to θ₂ (indicated by reference number 1140 in FIG. 11). Both angles θ₁ and θ₂ are larger than the critical angle of the flat lightguide 1020, and as a result both the first TIR ray 1110 as well as the second TIR ray 1130 are internally reflected upon reaching an interface between the material of the flat lightguide 1020 and the medium by which the flat lightguide 1020 is enclosed. Due to the total internal reflections of the light rays, light rays travel from the side of the flat lightguide 1020 where the light rays were incoupled to an opposite side of the flat lightguide 1020. At a predetermined position along the longitudinal direction of the flat lightguide 1020 (as viewed from a top-down perspective as shown in FIG. 11), the light rays impinge on the transmissive DOE 1070, upon which the light rays are outcoupled by the transmissive DOE 1070 toward the viewer's eye 800. The transmissive DOE 1070 may comprise a single volume hologram or metasurface, or a stack of volume holograms or metasurfaces, whereby each volume hologram or metasurface can be configured for operation at a single wavelength or for operation with two or more wavelengths. The transmissive DOE 1070 (e.g., when implemented as a volume hologram) may be composed of one or a combination of the following materials: photopolymers, silver halides, PTR glass, thermoplastics (e.g., Polymethyl methacrylate or PQ:PMMA), and dichromated gelatine (DCG). In some embodiments, a thickness of the transmissive DOE 1070 (e.g., when implemented as a volume hologram) may be at least about 5 μm, e.g., between about 500 μm and 30 mm, e.g., between about 1 mm and 3 mm, between about 1 mm and 10 mm. In some embodiments, the lightguide 1020 may be composed of one or a combination of the following materials: thermoset polymers (e.g., CR39, Trivex), thermoplastic polymers (e.g., PMMA, Zeonex), and glass. In some related embodiments, the lightguide 1020 may have a thickness between 2 mm and 6 mm.

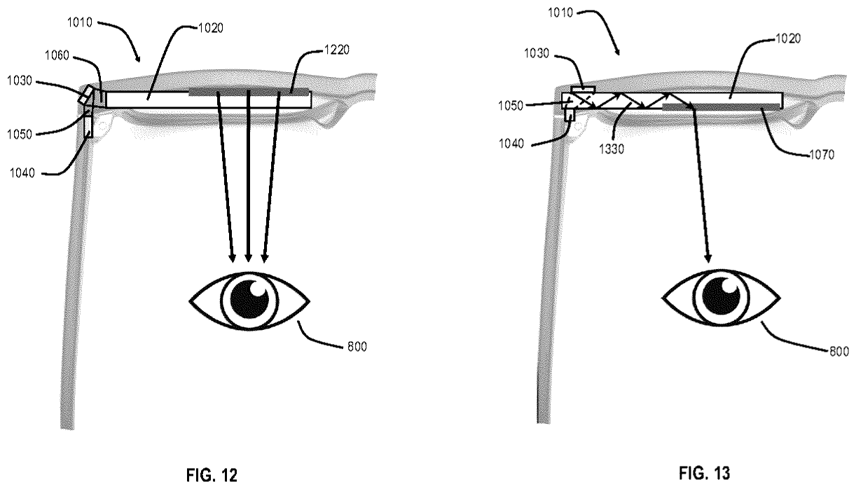

FIG. 12 illustrates a top view of a left side of another example of AR glasses 1010 with the flat lightguide 1020 comprising a reflective DOE 1220 (in contrast to the transmissive DOE 1070 in FIGS. 10 and 11). In some embodiments, the reflective DOE 1220 is implemented as a volume hologram (e.g., an HOE). In yet other embodiments, the reflective DOE 1220 is implemented as a metasurface. Also, as in the example AR glasses of FIG. 10, the illumination source 1040 provides an illumination beam 1050 to the SLM 1030, whereby the SLM 1030 modulates the amplitude, phase, and/or polarization of the illumination beam 1050, generating a modulated light beam 1060. The modulated light beam 1060 is coupled into the flat lightguide 1020 at an incoupling area of the flat lightguide 1020. In some embodiments, the incoupling area may comprise one or a combination of a diffraction grating (e.g., a surface-relief diffraction grating and/or a volume holographic grating) and/or a prism to facilitate the incoupling of the modulated light beam 1060 into the flat lightguide 1020. Light rays of the modulated light beam 1060 travel inside the flat lightguide 1020 under TIR (from the side of the flat lightguide 1020 where the modulated light beam 1060 is incoupled to the opposite side). When a light ray of the modulated light beam 1060 inside the flat lightguide 1020 reaches (impinges on) the reflective DOE 1220, the light ray gets reflected by the reflective DOE 1220 towards the viewer's eye 800. The reflective DOE 1220 is positioned at an outer surface of the flat lightguide 1020 that is opposite to the outer surface of the flat lightguide 1020 that is closest to the viewer's eye 800, and as a consequence, the light rays, after being reflected by the reflective DOE 1220, still travel through a portion of the flat lightguide 1020 before being outcoupled at the outer surface of the flat lightguide 1020 closest to the viewer's eye 800. The reflective DOE 1220 may comprise a single volume hologram or metasurface, or a stack of volume holograms or metasurfaces, whereby each volume hologram or metasurface can be configured for operation at a single wavelength or for operation with two or more wavelengths. The reflective DOE 1220 may be composed of one or a combination of the following materials: photopolymers, silver halides, PTR glass, thermoplastics (e.g., Polymethyl methacrylate or PQ:PMMA), and dichromated gelatine (DCG). In some embodiments, a thickness of the reflective DOE 1220 may be at least about 5 μm, e.g., between about 500 μm and 30 mm, e.g., between about 1 mm and 3 mm, between about 1 mm and 10 mm.

FIG. 13 illustrates a top view of a left side of another example of AR glasses 1010, whereby the SLM 1030 is attached to the flat lightguide 1020. The flat lightguide 1020 has a first outer surface that is closest to the viewer's eye 800 and a second outer surface that is opposite to the first outer surface. In FIG. 13, the SLM 1030 is attached to the second outer surface, and the illumination source 1040, which provides an illumination beam 1050 to the SLM 1030, is attached to the first outer surface. In some alternative embodiments, the SLM 1030 is attached to the first outer surface of the flat lightguide 1020 and the illumination source 1040 is attached to the second outer surface of the flat lightguide 1020. It should be understood that the different embodiments of the positioning of the SLM 1030 and of the optical fiber 326 relative to the curved lightguide 320 as explained in relation to FIGS. 5 and 6 may also be applicable to the positioning of the SLM 1030 and of the illumination source 1040 relative to the flat lightguide 1020. In some embodiments, both the SLM 1030 and the illumination source 1040 are attached to the same outer surface of the flat lightguide 1020 (e.g., both to the first outer surface of the flat lightguide 1020 or both to the second outer surface of the flat lightguide 1020) and a reflective element (such as reflective element 330 in relation to FIG. 5) is positioned at the outer surface of the flat lightguide 1020 opposite to the outer surface to which the SLM 1030 and the illumination source 1040 are attached, in order for the illumination beam 1050, as provided by the illumination source 1040, to be reflected by the reflective element towards the SLM 1030. In some embodiments, one or more absorbers may be integrated with the flat lightguide 1020 (such as the one or more absorbers 340 as explained in relation to FIGS. 5 and 6). FIG. 13 also illustrates an example TIR ray 1330 that travels inside the flat lightguide 1020 and is outcoupled by the transmissive DOE 1070 towards the viewer's eye 800.

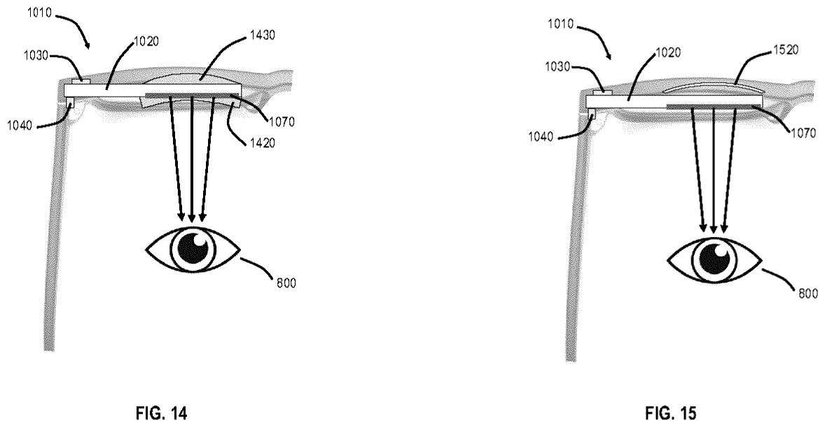

FIG. 14 illustrates a top view of a left side of another example of AR glasses 1010 comprising the flat lightguide 1020, a plano-concave lens 1420, and a plano-convex lens 1430. The flat lightguide 1020 has a first outer surface that is closest to the viewer's eye and a second outer surface that is opposite to the first outer surface. The plano-concave lens 1420 comprises a flat surface and a concave surface, wherein the plano-concave lens 1420 is positioned with its flat surface facing the first outer surface of the flat lightguide 1020 within the line of sight of the viewer's eye 800. The plano-convex lens 1430 comprises a flat surface and a convex surface, wherein the plano-convex lens 1430 is positioned with its flat surface facing the second outer surface of the flat lightguide 1020 within the line of sight of the viewer's eye 800. The curvature of the concave surface of the plano-concave lens 1420 and/or the curvature of the convex surface of the plano-convex lens 1430 is configured to accommodate a viewer's prescription (the plano-concave lens 1420 and/or the plano-convex lens 1430 provide the prescribed optical correction to correct for a viewer's vision impairment). In some embodiments, one of the plano-concave lens 1420 or the plano-convex lens 1430 may be omitted. In other embodiments, the plano-concave lens 1420 and/or the plano-convex lens 1430 may be replaced with a plano-lens whereby the curved surface exhibits one of the following curvatures: a cylindrical curvature, a spherocylindrical curvature, an aspherical curvature, a toroidal curvature, or a free-form curvature.

FIG. 15 illustrates a top view of a left side of another example of AR glasses 1010 comprising the flat lightguide 1020 and a curved lens 1520 (e.g., a meniscus lens) that has been positioned in front of the second outer surface of the flat lightguide 1020 (the curved lens 1520 is closer to the second outer surface than to the first outer surface of the flat lightguide 1020) in the line of sight of the viewer's eye 800. The curved lens 1520 comprises a convex curvature at one side and a concave curvature at the opposite side, whereby the concave curvature is facing the second outer surface of the flat lightguide 1020. In some other embodiments, the curved lens 1520 may be replaced by a lens having one or both surfaces exhibiting one or more of the following curvatures: a cylindrical curvature, a spherocylindrical curvature, an aspherical curvature, a toroidal curvature, or a freeform curvature. In other embodiments, the curved lens 1520 may be positioned behind the first outer surface of the flat lightguide 1020 (the curved lens 1520 is closer to the first outer surface than to the second outer surface of the flat lightguide 1020), with the convex surface of the curved lens 1520 facing the second outer surface of the flat lightguide 1020.

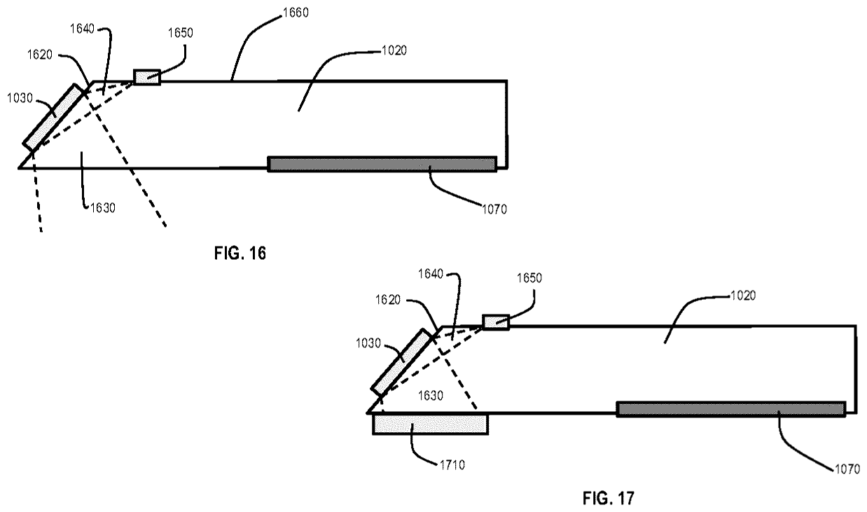

FIG. 16 illustrates a flat lightguide 1020 whereby the SLM 1030 is attached to a slanted side surface 1620 of the flat lightguide 1020. From the top view perspective of FIG. 16, the angle between the slanted side surface 1620 and the front-facing surface 1660 of the flat lightguide 1020 is greater than 90 degrees. A converging illumination beam 1630 is provided to the SLM 1030, whereby the SLM 1030 modulates the amplitude, phase, and/or polarization of the illumination beam 1630, resulting in a modulated light beam. Light rays of the modulated light beam travel inside the flat lightguide 1020 through TIR and are outcoupled by the transmissive DOE 1070. The illumination of the SLM 1030 by the illumination beam 1630 also results in a zero-order diffraction light beam 1640. The zero-order diffraction light beam 1640 converges and is captured by an absorber 1650 (for example, absorber 340 in FIG. 5). In some other embodiments, absorber 1650 is replaced by one or more photodiodes. In some other related embodiments, the flat lightguide 1020 with the slanted side surface 1620 comprises a reflective DOE (e.g., reflective DOE 1220 in FIG. 12) at the front-facing surface 1660 instead of the transmissive DOE 1070. In some alternative embodiments, the angle between the slanted side surface 1620 and the front-facing surface 1660 of the flat lightguide 1020 is less than 90 degrees (from a top view perspective like in FIG. 16), whereby the illumination beam 1630 is fed into the lightguide 1020 towards the SLM 1030 from the front-facing surface 1660.

FIG. 17 illustrates a similar flat lightguide 1020 as in FIG. 16, further comprising an optical element 1710 that converts an incoming illumination beam into a converging illumination beam 1630 incident on the SLM 1030. In some embodiments, the optical element 1710 includes a lens or a mirror. In alternative embodiments, the optical element 1710 may include a structure on a surface of the flat lightguide 1020 made of the same material as the flat lightguide 1020. In yet other embodiments, the optical element 1710 may be a diffraction grating, either embedded on a surface of the flat lightguide 1020 or attached to a surface of the flat lightguide 1020.

The following are some examples of embodiments of the present disclosure.

Example 1 provides a holographic display arrangement, including a lightguide having a concave outer surface and a convex outer surface (i.e., the lightguide is a curved lightguide); and an SLM attached to a portion of the lightguide, in which: the lightguide includes a first HOE for outcoupling light incident thereon and a second HOE for outcoupling light incident thereon, the first HOE is over a portion of the concave outer surface of the lightguide, and the second HOE is over a portion of the convex outer surface of the lightguide.

Example 2 provides the holographic display arrangement according to example 1, in which the first HOE is a transmissive HOE and the second HOE is a reflective HOE.

Example 3 provides the holographic display arrangement according to examples 1 or 2, in which the first HOE is closer to the SLM than the second HOE.

Example 4 provides the holographic display arrangement according to any one of examples 1-3, in which the first HOE and the second HOE do not overlap.

Example 5 provides the holographic display arrangement according to any one of examples 1-3, in which the first HOE and the second HOE partially overlap.

Example 6 provides the holographic display arrangement according to any one of the preceding examples, in which the holographic display arrangement is an AR display hardware.

Example 7 provides the holographic display arrangement according to any one of the preceding examples, in which the holographic display arrangement is AR glasses.

Example 8 provides the holographic display arrangement according to any one of examples 1-7, in which: the first HOE or the second HOE includes a stack of at least a first volume hologram and a second volume hologram, the first volume hologram is configured for operation at a first wavelength, the second volume hologram is configured for operation at a second wavelength, and the first wavelength is different from the second wavelength.

Example 9 provides the holographic display arrangement according to any one of examples 1-7, in which: the first HOE or the second HOE includes a volume hologram, and the volume hologram is configured for operation at multiple wavelengths.

Example 10 provides a holographic display arrangement, including a curved lightguide having a first outer surface and a second outer surface; and an SLM attached to a portion of the lightguide, in which: the curved lightguide includes a transmissive DOE over a portion of the first outer surface of the lightguide, the curved lightguide includes a reflective DOE over a portion of the second outer surface of the lightguide, and each of the transmissive DOE and the reflective DOE is configured to outcouple light incident thereon.

Example 11 provides the holographic display arrangement according to example 10, in which the transmissive DOE is closer to the SLM than the reflective DOE.

Example 12 provides the holographic display arrangement according to any one of examples 10-11, in which the transmissive DOE and the reflective DOE do not overlap.

Example 13 provides the holographic display arrangement according to any one of examples 10-11, in which the transmissive DOE and the reflective DOE partially overlap.

Example 14 provides the holographic display arrangement according to any one of examples 10-13, in which: the transmissive DOE includes a first volume hologram, and the reflective DOE includes a second volume hologram.

Example 15 provides the holographic display arrangement according to any one of examples 10-13, in which: the transmissive DOE or the reflective DOE includes a stack of at least a first volume hologram and a second volume hologram, the first volume hologram is configured for operation at a first wavelength, the second volume hologram is configured for operation at a second wavelength, and the first wavelength is different from the second wavelength.

Example 16 provides the holographic display arrangement according to any one of examples 10-13, in which: the transmissive DOE or the reflective DOE includes a volume hologram, and the volume hologram is configured for operation at multiple wavelengths.

Example 17 provides the holographic display arrangement according to any one of examples 10-13, in which: the transmissive DOE includes a first metasurface, and the reflective DOE includes a second metasurface.

Example 18 provides the holographic display arrangement according to any one of examples 10-13, in which: the transmissive DOE or the reflective DOE includes a stack of at least a first metasurface and a second metasurface, the first metasurface is configured for operation at a first wavelength, the second metasurface is configured for operation at a second wavelength, and the first wavelength is different from the second wavelength.

Example 19 provides the holographic display arrangement according to any one of examples 10-13, in which: the transmissive DOE or the reflective DOE includes a metasurface, and the metasurface is configured for operation at multiple wavelengths.

Example 20 provides the holographic display arrangement according to any one of examples 10-19, in which the holographic display arrangement is an AR display hardware.

Example 21 provides the holographic display arrangement according to any one of examples 10-19, in which the holographic display arrangement is AR glasses.

Example 22 provides AR glasses, including a lightguide having a first surface and a second surface opposite the first surface; a first volume hologram having a first surface on a portion of the first surface of the lightguide, and having a second surface opposite the first surface of the first volume hologram; and a second volume hologram having a first surface on a portion of the second surface of the lightguide, and having a second surface opposite the first surface of the second volume hologram, in which: a first portion of light is incident on the first surface of the first volume hologram, the first volume hologram is to outcouple a portion of the first portion of light from the second surface of the first volume hologram, a second portion of light is incident on the first surface of the second volume hologram, and the second volume hologram is to outcouple a portion of the second portion of light from the first surface of the second volume hologram.

Example 23 provides the AR glasses according to example 22, in which the first surface is a concave surface and the second surface is a convex surface.

Example 24 provides the AR glasses according to example 23, in which the first volume hologram and the second volume hologram do not overlap.

Example 25 provides the AR glasses according to example 23, in which the first volume hologram and the second volume hologram partially overlap.

Example 26 provides the AR glasses according to any one of examples 23-25, further including an SLM attached to the lightguide, in which: the first portion of light includes a first portion of a first-order diffraction light output by the SLM, and the second portion of light includes a second portion of the first-order diffraction light output by the SLM.

Example 27 provides the AR glasses according to example 26, in which the first volume hologram is closer to the SLM than the second volume hologram.

Example 28 provides the AR glasses according to any one of examples 26-27, in which the SLM is attached to the second surface of the lightguide.

Example 29 provides the AR glasses according to example 28, further including an optical illumination holographic display arrangement (e.g., an optical fiber) to provide light to illuminate the SLM, in which the optical illumination holographic display arrangement is coupled to the second surface of the lightguide.

Example 30 provides the AR glasses according to example 29, further including a reflective element to reflect the light from the optical illumination holographic display arrangement to be incident on the SLM.

Example 31 provides the AR glasses according to example 30, in which the reflective element is at the first surface of the lightguide.

Example 32 provides the AR glasses according to example 28, further including an optical illumination holographic display arrangement (e.g., an optical fiber) to provide light to illuminate the SLM, in which the optical illumination holographic display arrangement is coupled to the first surface of the lightguide.

Example 33 provides the AR glasses according to any one of examples 26-27, in which the SLM is attached to a surface of the lightguide that is between the first surface of the lightguide and the second surface of the lightguide.

Example 34 provides the AR glasses according to any one of examples 26-27, in which the SLM is attached to the first surface of the lightguide.

Example 35 provides a holographic display arrangement, including a curved lightguide having a first outer surface and a second outer surface; an illumination source; and an SLM that modulates light as provided by the illumination source to output modulated light, in which: the curved lightguide includes an incoupling window to incouple the modulated light output by the SLM into the curved lightguide, the curved lightguide includes a transmissive diffractive optical element (DOE) over a portion of the first outer surface of the lightguide, the curved lightguide includes a reflective DOE over a portion of the second outer surface of the lightguide, and each of the first DOE and the second DOE is configured to outcouple light incident thereon.

Example 36 provides the holographic display arrangement according to example 35, in which: the transmissive DOE includes a first volume hologram, and the reflective DOE includes a second volume hologram.

Example 37 provides the holographic display arrangement according to example 35, in which: the transmissive DOE or the reflective DOE includes a stack of at least a first volume hologram and a second volume hologram, the first volume hologram is configured for operation at a first wavelength, the second volume hologram is configured for operation at a second wavelength, and the first wavelength is different from the second wavelength.

Example 38 provides the holographic display arrangement according to example 35, in which: the transmissive DOE or the reflective DOE includes a volume hologram, and the volume hologram is configured for operation at multiple wavelengths.

Example 39 provides the holographic display arrangement according to example 35, in which: the transmissive DOE includes a first metasurface, and the reflective DOE includes a second metasurface.

Example 40 provides the holographic display arrangement according to example 35, in which: the transmissive DOE or the reflective DOE includes a stack of at least a first metasurface and a second metasurface, the first metasurface is configured for operation at a first wavelength, the second metasurface is configured for operation at a second wavelength, and the first wavelength is different from the second wavelength.

Example 41 provides the holographic display arrangement according to example 35, in which: the transmissive DOE or the reflective DOE includes a metasurface, and the metasurface is configured for operation at multiple wavelengths.

The foregoing description of illustrative embodiments, as well as the description of the Abstract, is not intended to be exhaustive or to restrict the scope of the disclosure to the specific implementations presented. Although particular examples and embodiments have been provided for clarity and illustration, those skilled in the relevant technical field will recognize that various alternative approaches, modifications, and equivalent variations may be made without departing from the scope of the disclosure. Such modifications are considered to fall within the breadth and spirit of the concepts described above.

1. A holographic display arrangement, comprising:
a lightguide having a concave outer surface and a convex outer surface; and
a spatial light modulator (SLM) attached to a portion of the lightguide,
wherein:
the lightguide includes a first holographic optical element (HOE) for outcoupling light incident thereon and a second HOE for outcoupling light incident thereon,
the first HOE is over a portion of the concave outer surface of the lightguide, and
the second HOE is over a portion of the convex outer surface of the lightguide.

2. The holographic display arrangement according to claim 1, wherein the first HOE is a transmissive HOE and the second HOE is a reflective HOE.

3. The holographic display arrangement according to claim 1, wherein the first HOE is closer to the SLM than the second HOE.

4. The holographic display arrangement according to claim 1, wherein the first HOE and the second HOE do not overlap.

5. The holographic display arrangement according to claim 1, wherein the first HOE and the second HOE partially overlap.

6. The holographic display arrangement according to claim 1, wherein the holographic display arrangement is an AR display hardware.

7. The holographic display arrangement according to claim 1, wherein the holographic display arrangement is AR glasses.

8. The holographic display arrangement according to claim 1, wherein:
the first HOE or the second HOE includes a stack of at least a first volume hologram and a second volume hologram,
the first volume hologram is configured for operation at a first wavelength,
the second volume hologram is configured for operation at a second wavelength, and
the first wavelength is different from the second wavelength.

9. The holographic display arrangement according to claim 1, wherein:
the first HOE or the second HOE includes a volume hologram, and
the volume hologram is configured for operation at multiple wavelengths.

10. A holographic display arrangement, comprising:
a curved lightguide having a first outer surface and a second outer surface; and
a spatial light modulator (SLM) attached to a portion of the lightguide,
wherein:
the curved lightguide includes a transmissive diffractive optical element (DOE) over a portion of the first outer surface of the lightguide,
the curved lightguide includes a reflective DOE over a portion of the second outer surface of the lightguide, and
each of the transmissive DOE and the reflective DOE is configured to outcouple light incident thereon.

11. The holographic display arrangement according to claim 10, wherein the transmissive DOE is closer to the SLM than the reflective DOE.

12. The holographic display arrangement according to claim 10, wherein the transmissive DOE and the reflective DOE do not overlap.

13. The holographic display arrangement according to claim 10, wherein the transmissive DOE and the reflective DOE partially overlap.

14. The holographic display arrangement according to claim 10, wherein:
the transmissive DOE includes a first volume hologram, and
the reflective DOE includes a second volume hologram.

15. The holographic display arrangement according to claim 10, wherein:
the transmissive DOE or the reflective DOE includes a stack of at least a first volume hologram and a second volume hologram,
the first volume hologram is configured for operation at a first wavelength,
the second volume hologram is configured for operation at a second wavelength, and
the first wavelength is different from the second wavelength.

16. The holographic display arrangement according to claim 10, wherein:
the transmissive DOE or the reflective DOE includes a volume hologram, and
the volume hologram is configured for operation at multiple wavelengths.

17. The holographic display arrangement according to claim 10, wherein:
the transmissive DOE includes a first metasurface, and
the reflective DOE includes a second metasurface.

18. The holographic display arrangement according to claim 10, wherein:
the transmissive DOE or the reflective DOE includes a stack of at least a first metasurface and a second metasurface,
the first metasurface is configured for operation at a first wavelength,
the second metasurface is configured for operation at a second wavelength, and
the first wavelength is different from the second wavelength.

19. Augmented reality (AR) glasses, comprising:
a lightguide having a first surface and a second surface opposite the first surface;
a first volume hologram having a first surface on a portion of the first surface of the lightguide, and having a second surface opposite the first surface of the first volume hologram; and
a second volume hologram having a first surface on a portion of the second surface of the lightguide, and having a second surface opposite the first surface of the second volume hologram,
wherein:
a first portion of light is incident on the first surface of the first volume hologram,
the first volume hologram is to outcouple a portion of the first portion of light from the second surface of the first volume hologram,
a second portion of light is incident on the first surface of the second volume hologram, and
the second volume hologram is to outcouple a portion of the second portion of light from the first surface of the second volume hologram.

20. The AR glasses according to claim 19, further comprising:
a spatial light modulator (SLM) attached to the lightguide,
wherein:
the first portion of light includes a first portion of a first-order diffraction light output by the SLM,
and
the second portion of light includes a second portion of the first-order diffraction light output by the SLM.
